(19) United States
(12) Patent Application Publication
(10) Pub. No.: US 2004/0158549 A1
(43) Pub. Date: Aug. 12, 2004

(54) Method and apparatus for online transaction processing

(76) Inventors: Vladimir Matena, Redwood City, CA (US); Magnus Eriksson, Huddinge (SE); Jens Jensen, Mariefred (SE)

Correspondence Address: HOWREY SIMON ARNOLD & WHITE, LLP, BOX 34, 301 RAVENSWOOD AVE., MENLO PARK, CA, 94025, US

(21) Appl. No.: 10/774,207

(22) Filed: Feb. 6, 2004

Related U.S. Application Data
(60) Provisional application No. 60/454,510, filed on Mar. 12, 2003.
(60) Provisional application No. 60/445,639, filed on Feb. 7, 2003.
(60) Provisional application No. 60/508,150, filed on Sep. 30, 2003.
(60) Provisional application No. 60/519,904, filed on Nov. 14, 2003.

(51) Int. Cl. G06F 17/30

(52) U.S. Cl. 707/1

(57) ABSTRACT

Online transaction processing is one of the main applications of computer systems. A purpose of the present invention is to improve the performance and availability of online transaction processing systems. A system that uses the present invention may process more transactions per second and remains more available to its clients than systems using the prior art.

### CROSS-REFERENCE TO RELATED APPLICATIONS

This application claims priority to and incorporates in full U.S. Provisional Patent Application No. 60/454,510 titled METHOD AND APPARATUS FOR EXECUTING APPLICATIONS ON A DISTRIBUTED COMPUTER SYSTEM filed Mar. 12, 2003, U.S. Provisional Patent Application No. 60/445,639 titled METHOD AND APPARATUS FOR ONLINE TRANSACTION PROCESSING, filed Feb. 7, 2003, U.S. Provisional Patent Application No. 60/508,150 titled METHOD AND APPARATUS FOR EFFICIENT ONLINE TRANSACTION PROCESSING filed Sep. 30, 2003, and U.S. Provisional Patent Application No. 60/519,904 titled METHOD AND APPARATUS FOR EXECUTING APPLICATIONS ON A DISTRIBUTED COMPUTER SYSTEM filed Nov. 14, 2003.

### BACKGROUND OF THE INVENTION

Transaction processing (TP) has been one of the major applications of computer hardware and software technologies. Background information on TP technologies is provided in J. Gray and A. Reuter, Transaction Processing: Concepts and Techniques, Morgan Kaufman Publishers Inc., 1993. It defines a transaction processing systems as, “A transaction processing system provides tools to ease or automate application programming, execution, and administration. A transaction-processing application typically supports a network of devices that submit queries and updates to the application. Based on these inputs, the application maintains a database representing some real-world state. Application responses and outputs typically drive real-world actuators and transducers that alter or control the state. The applications, database, and network tend to evolve over several decades. Increasingly, the systems are geographically distributed, heterogeneous (they involve equipment from many different vendors), continuously available (there is no scheduled down-time), and have stringent response time requirements.”

Applications and areas of TP include: (i) Communications such as setting up and billing of telephone calls, electronic mail, instant messaging, etc. (ii) Finance such as banking, stock trading, auctions, point of sale, etc. (iii) Travel such as reservations and billing for airlines, hotels, cars, trains, etc. (iv) Manufacturing such as order entry, job and inventory planning and scheduling, accounting, etc. and (v) Process control such as control of factories, warehouses, steel, paper, and chemical plants, etc.

Transactions and associated concepts are well defined in the field of computer systems. Transactions include a collection of operations on physical and abstract application transactional states. Transaction requests include requests or input messages that start a transaction. Transaction programs include programs that execute the transaction. A transaction program may be a sequence of computer instructions that carries out a transaction. It may read and update an application's transactional state. A transaction program could also be an implementation of a method or procedure written in some programming language. A transactional state includes the state of an application that is modified by transaction programs in response to transaction requests. Transactional states are managed, in general, according to the ACID properties that are generally required for transaction processing systems. Atomicity means that a transaction's changes to the state are atomic, either all happen or none happen. These changes include database changes, messages, and actions on transducers. Consistency means a transaction is a correct transformation of the state. The actions taken as a group do not violate any of the integrity constraints associated with the state. This may require the transaction program to be a correct program. Isolation means that even though transactions execute concurrently, it appears to each transaction, T, that other individual transactions T′ and T″ are executed either before T or after T, but not both. However, there is no restriction on whether the transactions T′ and T″ appear to execute before or after transaction T. Some transactions such as T′ may appear to execute before transaction T while other transactions such as T″ may appear to execute after transaction T. Durability means that once a transaction completes successfully (commits), its changes to the state survive failures.

Transaction processing systems may generally be divided into two categories, online transaction process (OLTP) systems and batch transaction processing systems. The present invention may be used with either system (or any other transaction processing system) and preferably with OLTP systems.

The current art of OLTP spans several major software technologies, including database management systems (DBMS) as well as application servers. Application servers include J2EE and .Net servers. An older term for an application server is a transaction processing monitor (TPM).

Performance and availability are two conventional characteristics of an OLTP system. Performance is typically quantified as the number of transactions per second that a system can handle while meeting some target response time. Availability is typically quantified as the percentage of time that the system is available to handle transactions. One of the main technical challenges in building commercial OLTP systems is providing high performance and continuous availability at low cost.

In this disclosure, there is a differentiation between the state maintained by the transaction processing system and the state maintained in an external database. Therefore, the term “transactional state” is used instead of “database” to denote the state that is read and updated by the transactional programs. The term “database” is used to denote the state maintained by an external database management system that is not directly a part of the online transaction processing system.

### SUMMARY OF THE INVENTION

An online transaction processing system including the present invention achieves better performance and availability than systems constructed using prior art by various methods including close integration of transaction programs with their associated transactional state. A system of the present invention includes multiple hardware modules, each executing one or more application-server processes, and a communication module that allows clients to submit transaction requests and receive responses. Applications that execute on the system are divided into execution modules. Each execution module is assigned to an application-server process. An execution module can be in the active or backup role. An active execution module includes both the transaction programs' instructions and their associated transactional state. A backup execution module includes a copy of the transactional state and may also include the transaction programs' instructions. The application-server processes include the logic for managing the atomicity, consistency, isolation, and durability properties of the transactional state. The execution of a transaction includes an operation in which a communication module routing a transaction request to an application-server process that includes the active execution module with the state required by the transaction, the application-server process's invoking the target transaction program in the execution module, the transaction program's accessing the execution module's transactional state, and the application-server process's committing the transaction by sending a checkpoint message to another application-server process that includes the associated backup execution module.

The present invention also includes a method for synchronizing data in an external database with the transactional state maintained in the execution modules. One such method includes the operations of a transaction program triggering the scheduling of a database synchronization program, recording the scheduling in the transactional state in an execution module, checkpointing the scheduling record to the backup execution module, and executing a database synchronization program. The database synchronization program reads values of the transactional state and updates data in an external database management system with values derived from values of the transactional state. Advantages of this method over prior art include increased transaction throughput because of a reduced number of database operations and uninterrupted availability when the database is offline.

The present invention further includes a method for loading deactivated items of the transactional state that are needed by a transaction by using the values of data items in an external database. One of the advantages of this method over the methods of prior art is that a transaction does not block other transactions while it is loading the deactivated items from the database, thereby improving transaction throughput.

The invention further includes a method for synchronizing the values of transactional state items included in the execution modules with the values of data items in a database when the data items have been changed. The advantages of this method over the methods of prior art include increased transaction throughput because transactions do not block other transactions during database operations, and uninterrupted availability when the database is offline.

The present invention further includes methods for starting, stopping, and upgrading applications. The advantages of these methods over methods of the prior art include uninterrupted availability of applications during application upgrades.

The methods for online transaction processing included in this invention allows construction of an OLTP system that can provide high performance and continuous availability at much lower cost than the system constructed using prior art.

The present invention may be implemented with conventional hardware and software, e.g. servers or other processor-based system running known operating systems, database software and other applications in conjunction with conventional storage systems.

### BRIEF DESCRIPTION OF THE DRAWINGS

FIG. 1 illustrates a simplified representation of the three-tier architecture for transaction processing, which is one of the dominant forms of prior arts.

FIG. 2 is a representational diagram illustrating a transaction-processing application.

FIG. 2-A illustrates representational transactional state items.

FIG. 3 is a representational diagram illustrating an execution module and its components.

FIG. 4 is a representational diagram illustrating the partitioning of a transaction-processing application into execution modules.

FIG. 5 illustrates a representational hardware module suitable for being used with a method and system of the invention.

FIG. 6 illustrates an exemplary distribution of execution modules across application-server processes, and exemplary distribution of application-server processes across hardware modules.

FIG. 7 illustrates components involved in executing an exemplary transaction request.

FIG. 8 illustrates transactional state and pre-transaction values prior to executing an exemplary transaction.

FIG. 9 illustrates transactional state and pre-transaction values at the end of an exemplary transaction.

FIG. 10 illustrates content of a checkpoint message that is sent at the end of an exemplary transaction.

FIG. 11 illustrates a flow chart including steps of executing an exemplary transaction.

FIG. 12 illustrates a flow chart including steps of obtaining and releasing locks to synchronize a transaction execution with the execution of other transactions.

FIG. 13 illustrates a flow chart including steps of performance optimization by releasing locks before a checkpoint has completed.

FIG. 14 illustrates a representational diagram of components involved in a method for synchronizing data in an external database with the values of the transactional state.

FIG. 15 is a flow chart illustrating the modified steps from the flow chart in FIG. 11. The steps have been modified to include a trigger mechanism used for scheduling the execution of a database synchronization program.

FIG. 16 is a flow chart illustrating steps of executing a transaction in which database synchronization scheduling records are created during execution of the transactional program.

FIG. 17 is flow chart illustrating execution steps of a database synchronization program.

FIG. 18 is a flow chart illustrating an embodiment in which a database synchronization program uses a single database transaction to handle multiple scheduling records.

FIG. 19 is a flow chart illustrating steps of execution of a transaction that encounters missing transactional state items.

FIG. 20 depicts a system that includes a database trigger and state synchronization program used for synchronizing transactional state items with data items in a database.

FIG. 21 is a flow chart illustrating a method for synchronizing transactional state items with data items in a database using a database trigger.

FIG. 22 depicts an embodiment of the invention.

FIG. 23 illustrates an exemplary transaction program suitable for an embodiment of the invention.

FIG. 24 illustrates a representational runtime artifact that is suitable for an embodiment of the invention.

FIG. 25 illustrates an exemplary transaction program suitable for other embodiments of the inventions.

FIG. 26 illustrate an EJB local interface used in one embodiment of the invention.

FIG. 27 illustrates an exemplary embodiment of a trigger that schedules a database synchronization program.

FIG. 28 is a modification of the exemplary runtime artifact from FIG. 17 to account for the existence of the trigger.

FIG. 29 is a Java interface used by an exemplary method for executing database synchronization programs.

FIG. 30 is an EJB local interface used in one of the embodiments of a database synchronization program.

FIG. 31 is an EJB local home interface used in one of the embodiments of a database synchronization program.

FIG. 32 illustrates an exemplary embodiment of a database synchronization program.

FIG. 33 illustrates a flow chart with an exemplary algorithm for managing the execution of database synchronization programs.

FIG. 34 illustrates a flow chart with an alternative embodiment of the algorithm of managing the execution of database synchronization programs.

FIG. 35 illustrates an online auction system as an exemplary application of a transaction processing system that embodies the present invention.

FIG. 36 depicts the execution module of the online auction application that executes on an exemplary transaction processing system that embodies the present invention.

FIG. 37 illustrates a UML (Unified Modeling Language) diagram depicting the Enterprise JavaBeans of an exemplary online auction application.

FIGS. 38 and 39 illustrate an exemplary implementation of an Enterprise JavaBean that uses a method for synchronizing an external database with the transactional state.

FIGS. 40 and 41 illustrate an exemplary method for executing database synchronization transactions.

FIG. 42 illustrates a service control point in a telecommunication network as another exemplary application of a transaction processing system that embodies the present invention.

FIG. 43 illustrates one of alternative embodiments of a method for synchronizing a database.

FIG. 44 is a representational diagram illustrating an Execution Control System used with some embodiments of the invention.

FIG. 45 illustrates an exemplary distributed computer system including nodes interconnected by a network suitable for including an Execution Control System.

FIG. 46 is a representational diagram illustrating the internal structure of a representational Execution Controller.

FIG. 47 is a representational diagram illustrating an internal structure of a Service Application Controller.

FIG. 48 is a representational diagram illustrating an internal structure of a Java Application Controller.

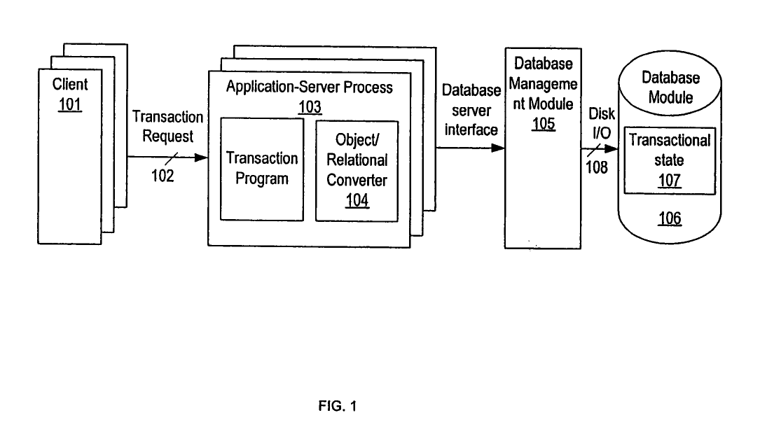

### DETAILED DESCRIPTION OF THE INVENTION

An online transaction processing system including the present invention achieves better performance and availability than systems constructed using prior art by close integration of transaction programs with their associated transactional states. The system may be implemented with components or modules. The components and modules may include hardware (including electronic and/or computer circuitry), firmware and/or software (collectively referred to herein as “logic”). A component or module can be implemented to capture any of the logic described herein.

The online transaction processing system uses multiple hardware modules, each executing one or more application-server processes, and a communication module that allows clients to submit transaction requests and receive responses. The applications that execute on the system are divided into execution modules. Each execution module is assigned to an application-server process. An execution module can be in the active or backup role. An active execution module includes both the transaction programs' instructions and their associated transactional state. A backup execution module includes a copy of the transactional state and may also include the transaction programs' instructions. The application-server processes include the logic for managing the atomicity, consistency, isolation, and durability properties of the transactional state. The execution of a transaction includes the operations of a communication module routing a transaction request to the application-server process that includes the active execution module with the state required by the transaction, the application-server process invoking the target transaction program in the execution module, the transaction program accessing the execution module's transactional state, and the application-server process committing the transaction by sending a checkpoint message to another application-server process that includes the associated backup execution module.

The invention further includes a method for synchronizing data in an external database with the transactional state maintained in the execution modules. Such a method includes the operations of a transaction program triggering the scheduling of a database synchronization program, recording the scheduling in the transactional state in the execution module, checkpointing the scheduling record to the backup execution module, and executing the database synchronization program. The database synchronization program reads values of the transactional state and updates data in an external database management system with values derived from values of the transactional state.

The invention further includes a method for loading deactivated items of the transactional state that are needed by a transaction by using the values of data items in an external database. The method may be implemented so that a transaction does not block other transactions while it is loading the deactivated items from the database, thereby improving transaction throughput.

The invention further includes a method for synchronizing the values of transactional state items included in the execution modules with the values of data items in a database when the data items have been changed. The method may be implemented to include increased transaction throughput because transactions do not block other transactions during database operations, and may possess uninterrupted availability when the database is offline.

The invention further includes methods for starting, stopping, and upgrading applications. The method may be implemented to include uninterrupted availability of applications during application upgrades.

### Description of Main Components

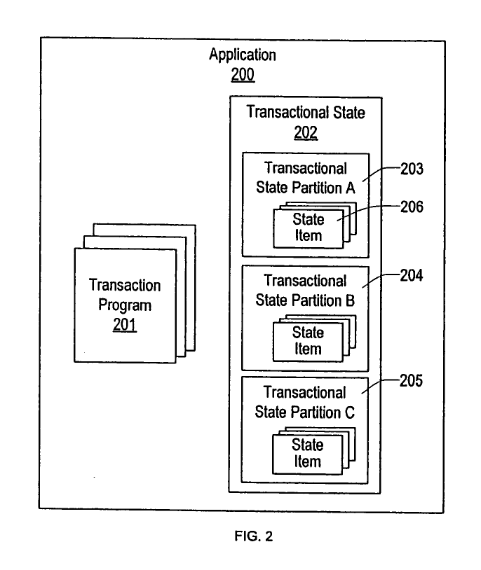

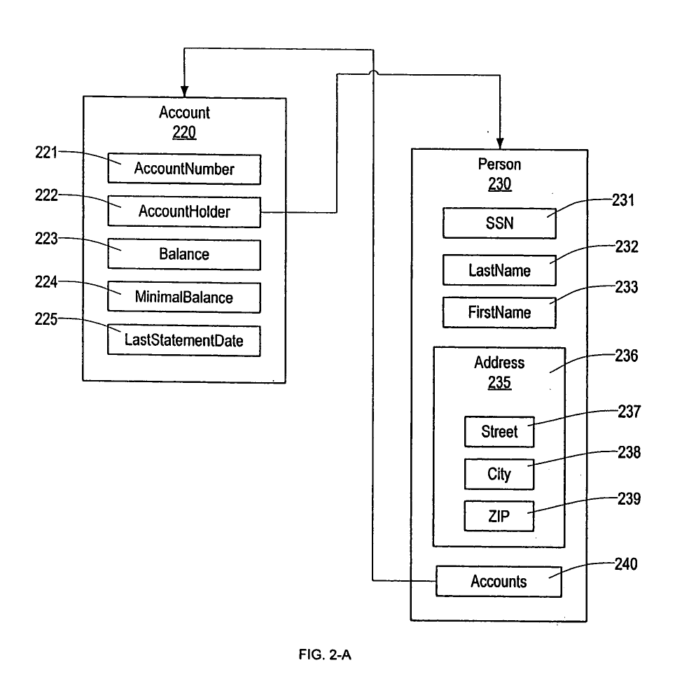

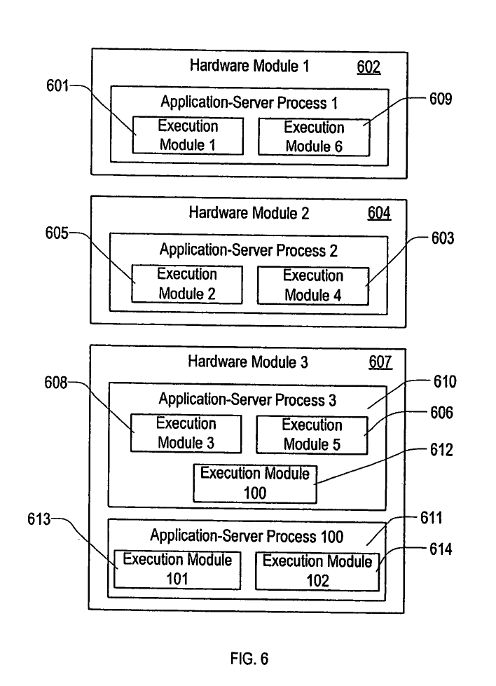

FIG. 2 illustrates a representational transaction-processing application suitable for the system of the present invention. A transaction-processing application 200 (“application” for short) includes one or more transaction programs 201 and their associated transactional state 202. In one embodiment, the components in FIG. 2 are logical (abstract) representations of structures. When an application executes, its parts are physically distributed across execution modules, which are distributed across application-server processes, which are in turn distributed across hardware modules, as illustrated in FIGS. 4 and 6.

The transactional state is logically divided into one or multiple transactional state partitions such that the execution of a transaction program results in accessing the transactional state only in a single partition. The transactional state of the exemplary application in FIG. 2 is divided into three partitions, A 203, B 204, and C 205.

If the transactional state is partitioned into multiple partitions, some partition criteria are used to determine the partition to assign each transactional state item. For example, transactional state items representing banking accounts could be partitioned into 10 partitions by using the last digit of the account number.

Each transactional state partition includes transactional state items 206. A transactional state item is any element of the transactional state that can be individually read, created, removed, or modified (“accessed” generally) by the transaction programs. A transactional state item may include and/or refer to other transactional state items. The implementation of the transactional state items is dependent on the technology used in a given embodiment of the invention.

FIG. 2-A depicts several exemplary transactional state items. The transactional state item Account 220 includes the transactional state items AccountNumber 221, AccountHolder 222, Balance 223, MinimalBalance 224, and LastStatementDate 225. The transactional state item AccountHolder 222 is a reference to another transactional state item, the transactional state item Person 230. The transactional state item Person 230 includes the transactional state items SSN 231, LastName 232, FirstName 233, Address 235, and Accounts 240. Address 235 includes transactional state items Street 237, City 238, and ZIP 239. The transactional state item Accounts 240 includes a collection of references to accounts owned by the person, including a reference to the Account 220.

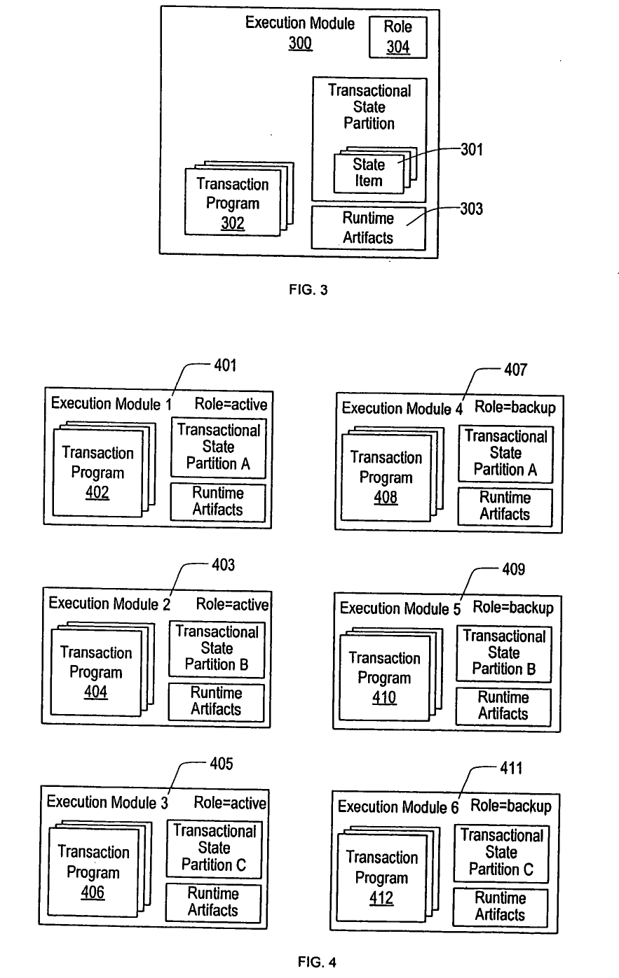

FIG. 3 describes a representational diagram illustrating an execution module 300 and its components. An execution module includes the transactional state items 301 of a partition. An execution module may also include the transaction programs 302 that access the transactional state items 301, runtime artifacts 303, and a role indicator 304.

Runtime artifacts are objects including instructions and data generated automatically by an application-server process, or its associated tools. The exact functions provided by the runtime artifacts depend on the embodiment of the invention. In general, runtime artifacts can perform any of the following functions: interpose on the execution of the transaction programs to allow the application-server process to inject its transaction management; store the current and pre-transaction values of the transactional state items; bind the values of the transactional state items with the programming language variables of the transaction programs; assist in the extraction of the values of the transactional state items in the active execution module for the purpose of sending a checkpoint message; assist in updating the values of the transactional state items in the backup execution module from the checkpoint message; and assist in synchronizing data items in an external database with the values of the transactional state items. In some embodiments of the invention, these described functions are already present in the transaction programs or the application-server process and therefore do not have to be included in the runtime artifacts.

The value of the execution module's role indicator 304 is either “active” or “backup”. An execution module is in the “active” role if it is enabled to receive and process transaction requests. An execution module is in the “backup” role if it is disabled from receiving and processing transaction requests, and is configured to receive the checkpoint messages sent from the application-server process holding the active execution module associated with the backup execution module. An active execution module includes the transaction programs 302 that access the transactional state 301 in the execution module. A backup execution module is not required to include the transaction programs, although in some embodiments it may.

FIG. 4 is a diagram illustrating the partitioning of the exemplary application into execution modules. For each transactional state partition, an active and backup execution module is created. Each execution module includes the transactional state partition, the transaction programs that access the transactional state items within the transactional state partition, and the runtime artifacts.

Execution Module 1 401 includes the transactional programs 402 from the application in FIG. 2 and the transactional state items from partition A. Execution Module 1 is in the active role.

Similarly, Execution Module 2 403 includes the transactional programs 404 from the application in FIG. 2 and the transactional state items from partition B. Execution Module 2 is in the active role.

Similarly, Execution Module 3 405 includes the transactional programs 406 from the application in FIG. 2 and the transactional state items from partition C. Execution Module 3 is in the active role.

Execution Module 4 407 includes the transactional programs 408 from the application in FIG. 2 and the transactional state items from partition A. Execution module 4 is in the backup role.

Similarly, Execution Module 5 409 includes the transactional programs 410 from the application in FIG. 2 and the transactional state items from partition B. Execution module 5 is in the backup role.

Similarly, Execution Module 6 411 includes the transactional programs 412 from the application in FIG. 2 and the transactional state items from partition C. Execution module 6 is in the backup role.

Although the exemplary application includes multiple transactional state partitions, an application's transactional state could include only a single partition. In such case, the application would include only two execution modules: an active and backup execution module, each holding the entire transactional state.

Although the description of the invention associates each active execution module with a single backup execution module, the invention also permits associating each active execution module with multiple backup execution modules, each located on a different hardware module, to improve tolerance to failures.

There are two main approaches to distribute checkpoints when there are multiple backup execution modules. In the first approach, the active execution module sends checkpoint messages to all its associated backup execution modules. In the second approach, the backup execution modules are daisy-chained. Therefore the active execution module sends the checkpoint message to the first backup execution module, which in turn sends it to the second backup execution module, and so on.

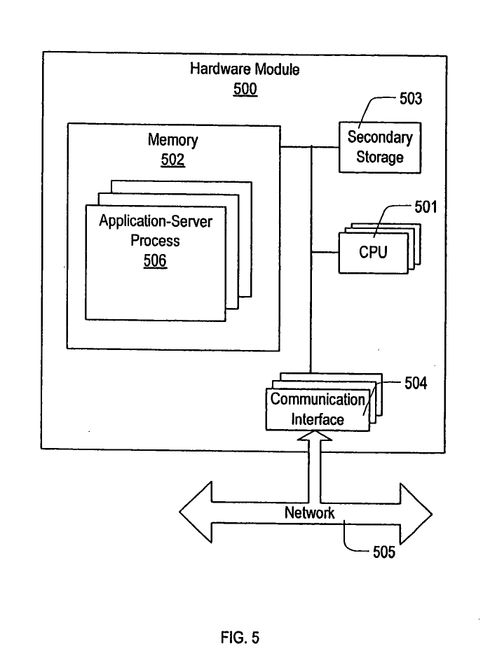

FIG. 5 illustrates a representational hardware module 500 of the invention. A hardware module includes a computer system comprising one or more central-processing units (CPU) 501, main memory 502, optional secondary storage 503, and one or more communication interfaces 504. The hardware module may be implemented with a hardware server. The communication interfaces 504 allow a hardware module to communicate with other hardware modules and with other computers, including the client computers, over a network 505. The hardware module's main memory 502 is capable of storing program instructions and data of one or more application-server processes 506.

FIG. 6 illustrates an exemplary distribution of execution modules across application-server processes, and an exemplary distribution of application-server processes across hardware modules. Execution modules 1 through 6 correspond to the execution modules in FIG. 4. The hardware modules in FIG. 6 are instances of the hardware module described in FIG. 5.

Although it is possible to construct a transaction processing system that has only a single hardware module, the present invention usually involves a system including at least two hardware modules, so that it is possible to distribute the active and backup execution modules such that a backup execution module is located on a different hardware module than its corresponding active execution module. Such distribution of the active and backup execution modules is a desirable feature for a system designed to provide continuous availability.

The exemplary distribution of execution modules depicted in FIG. 6 meets the continuous availability requirement. Execution Module 1 601, which is the active execution module for transactional state Partition A is located on hardware module 1 602, while execution module 4 603, which is the associated backup execution module for Partition A, is located on hardware module 2 604. Similarly, execution module 2 605, which is the active execution module for transactional state Partition B is located on hardware module 2 604, while execution module 5 606, which is the associated backup execution module for Partition B, is located on hardware module 3 607; and execution module 3 608, which is the active execution module for transactional state Partition C is located on hardware module 3 607, while execution module 6 609, which is the associated backup execution module for Partition C is located on hardware module 1 602. This exemplary distribution illustrates a possible configuration where no transactional state will be lost as a result of the failure of any single component (hardware module, application-server process, execution module).

FIG. 6 also illustrates a hardware module including multiple application-server processes 610, 611, and that an application-server process can include multiple execution modules. As FIG. 6 illustrates, an application-server process can include execution modules from the same or different applications. In FIG. 6, execution modules 1 though 6 are from one application, and execution modules 100 through 102 612, 613, 614 are from another application.

Some other criteria, such as security requirements, may be used to determine whether execution modules from different applications could be collocated in the same application-server process.

The transaction-processing system may perform the assignment of the active and backup execution modules such that the processing load is spread evenly across all available hardware modules. The transaction-processing system may use other load balancing schemes to perform this function as well.

The term execution control system refers to the set of algorithms employed by the transaction-processing system to manage, among other tasks, the number of execution modules; the assignment of execution modules to the application-server processes and hardware modules; the routing logic in the communication module; the partitioning of the transactional state according to some criteria. Some embodiments of the invention use the execution control system described in U.S. Provisional Patent Application No. 60/519,904, titled Method and Apparatus for Executing Applications on a Distributed Computer System for this purpose. The execution control system is also referred to as the distribution logic.

In some embodiments, if an active execution module fails because of any type of failure (both HW and SW failures are included), the execution control system detects the failure, changes the status of the backup execution module to active, and instructs the communication module to route requests to the new active execution module. The execution control system also creates a replacement backup execution module to protect the application from subsequent failures.

In other embodiments, if an active execution module fails, the execution control system detects the failure, creates a new active execution module, and reconstructs the transactional state in the new active execution module using the copy of the transactional state included in the backup execution module. The backup execution module will remain in the backup role after the failure.

In many embodiments, the system depicted in FIG. 6 includes multiple independent power supplies and multiple independent networks to allow the system to operate in the presence of failures of the power supplies and networks.

Transaction Request Execution

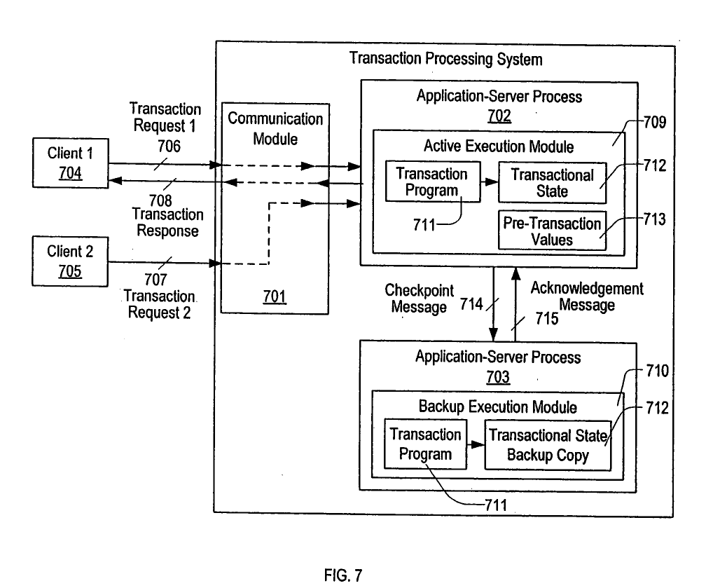

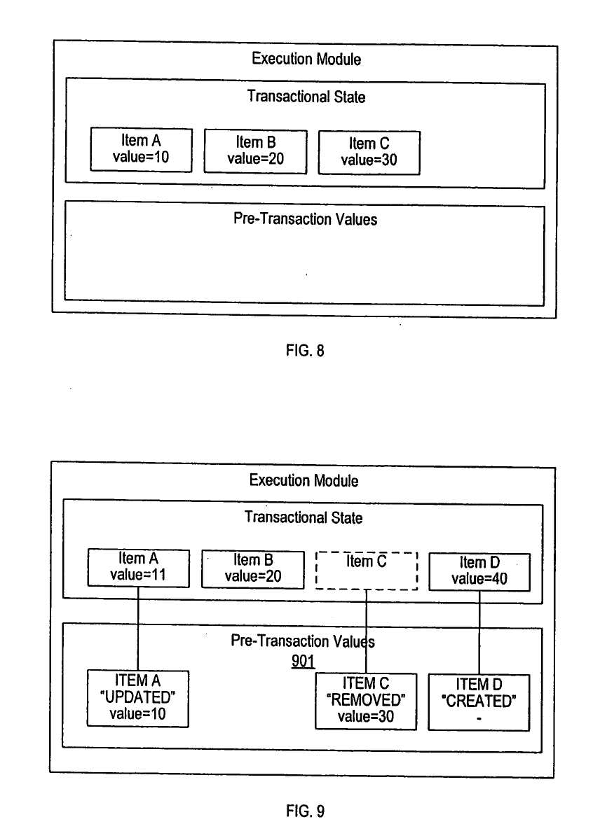

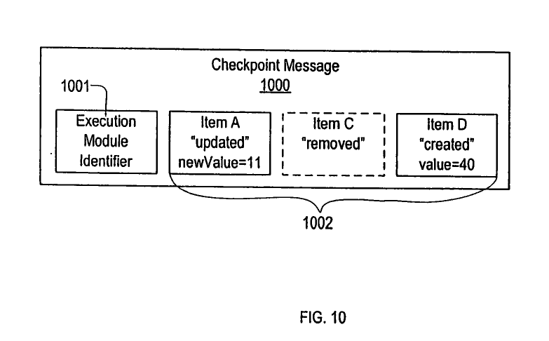

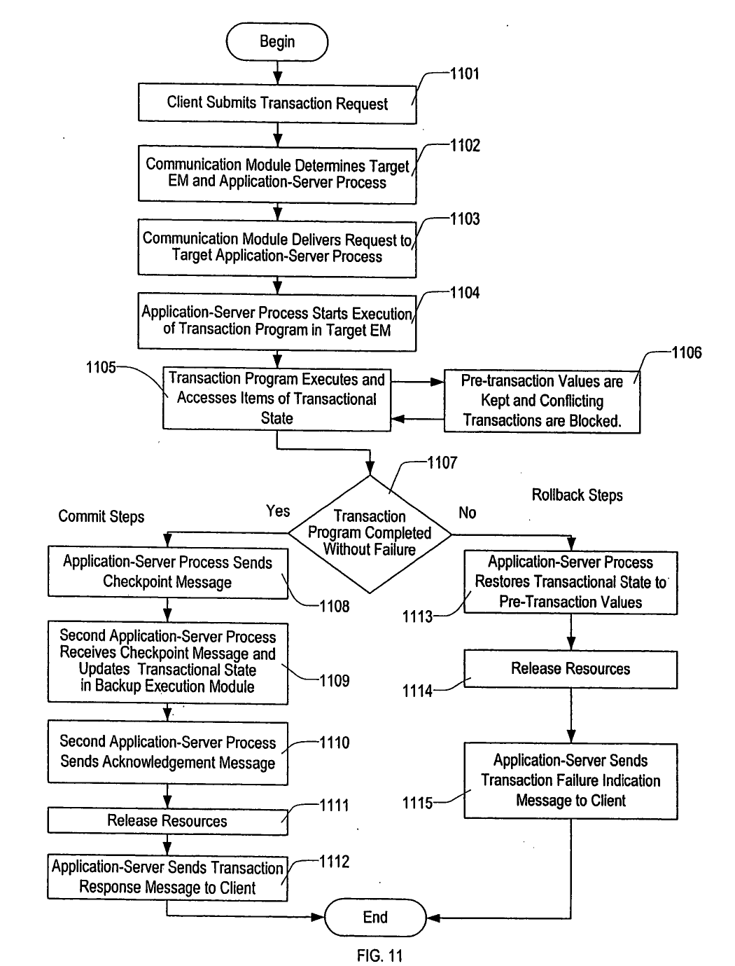

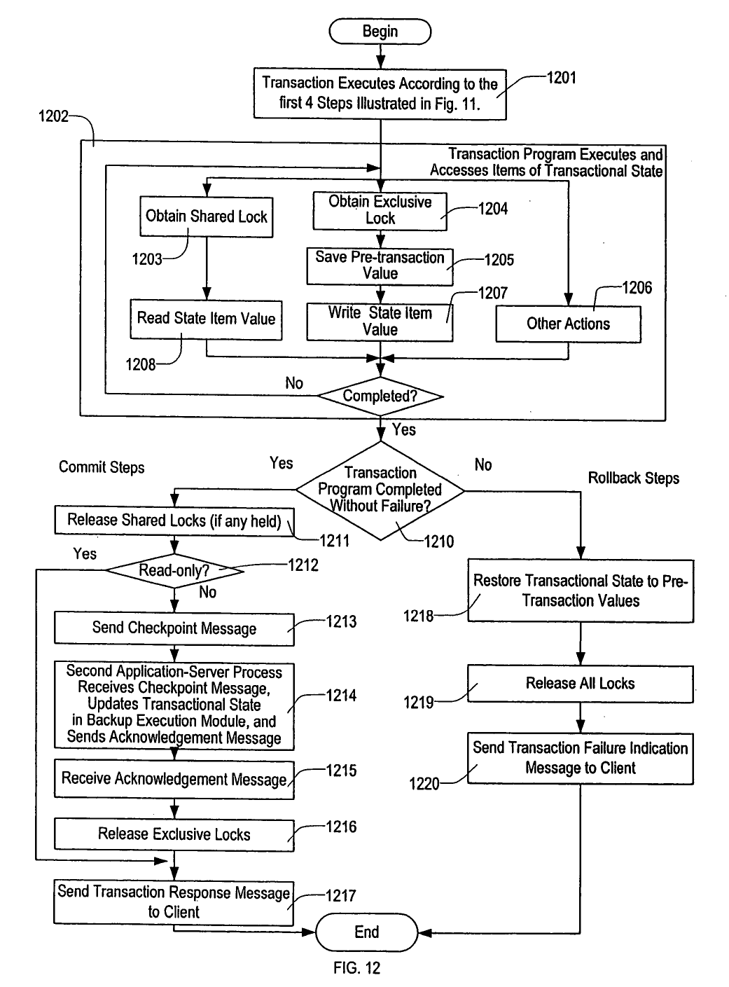

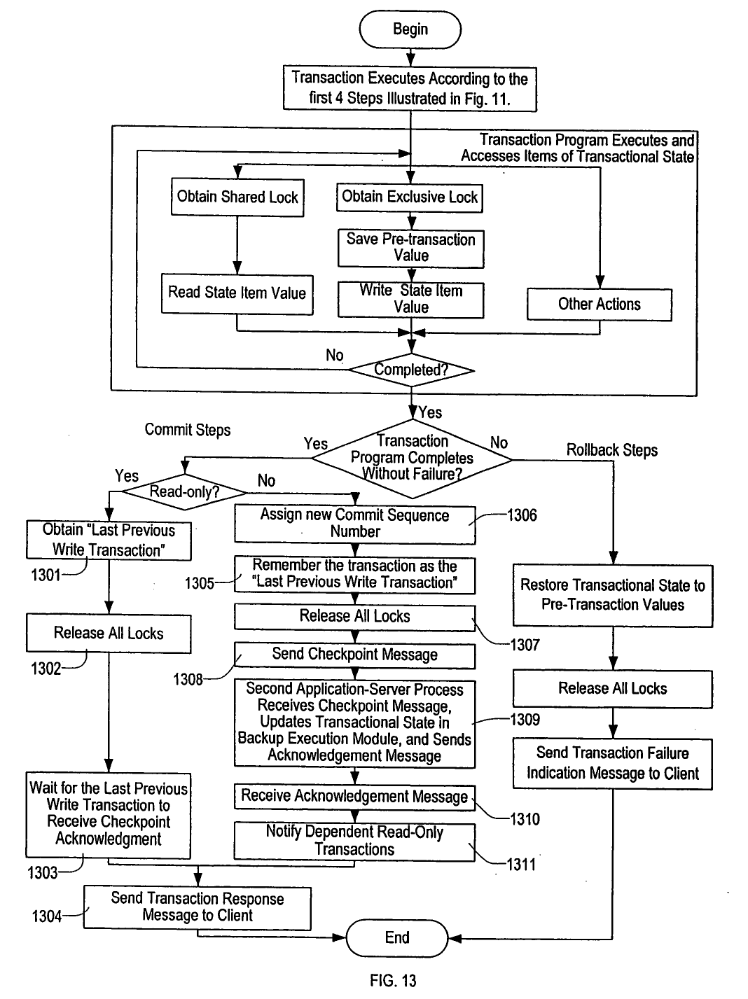

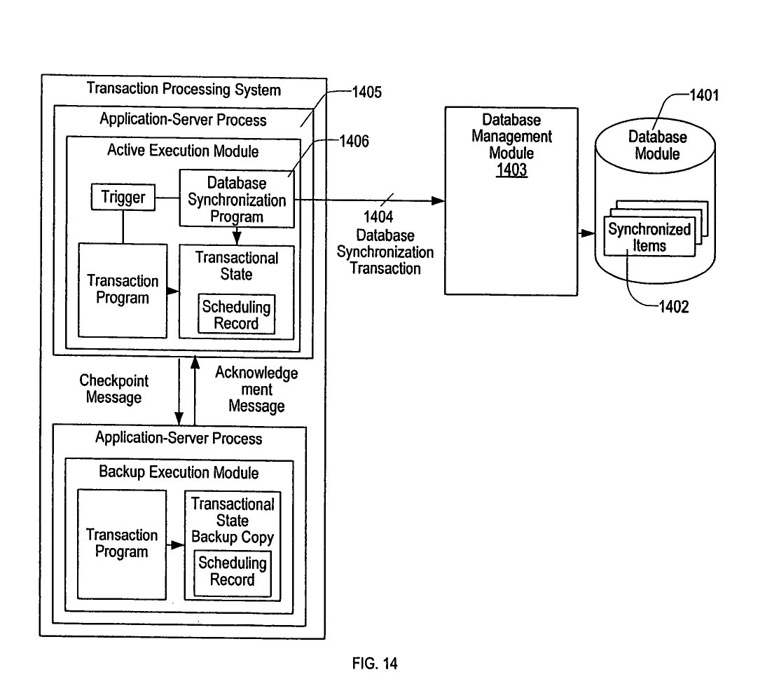

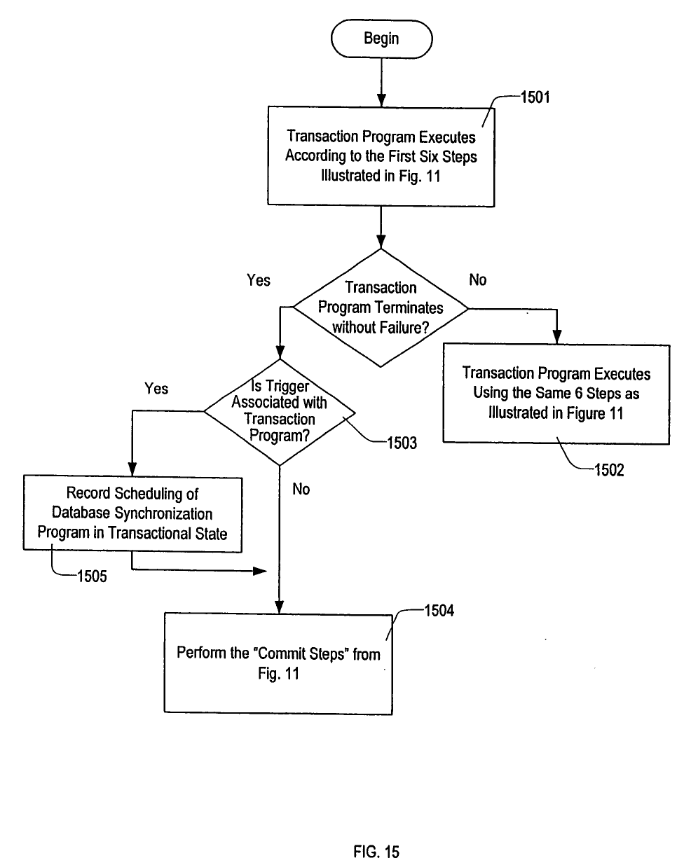

FIGS. 7 through 13 illustrate the execution of an exemplary transaction request of the present invention. FIG. 7 illustrates the components involved in an execution of a transaction request. FIG. 8 depicts the transactional state and pre-transaction values prior to executing a transaction. FIG. 9 illustrates a transactional state and pre-transaction values at the end of the transaction. FIG. 10 illustrates the content of a checkpoint message that is sent at the end of an exemplary transaction. FIG. 11 illustrates a flow chart illustrating the steps of executing an exemplary transaction. FIGS. 12 and 13 are flow charts illustrating how transactions executing concurrently are synchronized with each other in some embodiments of the invention.

FIG. 7 illustrates components of an exemplary transaction processing system involved in the execution of an exemplary transaction request. The illustrative transaction processing system includes a communication module 701 and two application-server processes 702, 703. The communication module 701 allows clients of the transaction processing system to submit their transaction requests and receive transaction responses. FIG. 7 also illustrates two such clients, client 1 704 and client 2 705.

A transaction request 706, 707 is a message to the transaction program including the identity of a transaction program to be executed and some parameters.

A transaction response 708 is a message including an indication of whether the transaction program execution has succeeded or failed. In the case of success, the response message 708 includes the transaction program results.

In FIG. 7, one application-server process 702 includes the active execution module 709, while the other application-server process 703 includes the associated backup execution module 710. The execution modules include the transaction programs 711 and transactional state 712.

FIG. 7 further illustrates that the active execution module 709 also includes pre-transaction values 713 that exist during the execution of the transaction. Pre-transaction values are values of the transactional state items as they were at the time before a transaction started. Keeping track of the pre-transaction values is important for achieving atomicity of transactions. If a transaction fails, the transaction processing system ensures that the transactional state will be restored to the pre-transaction values. A method of the present invention keeps track of pre-transaction values in the active execution module. Depending on the embodiment of the invention, the pre-transaction values could be kept in the variables of the transaction program, runtime artifacts, or in the application-server process.

The checkpoint message 714 is a message that is sent by the application-server process 702 that includes the active execution module 709 to the application-server process 703 that includes the associated backup execution module 710. The content of the checkpoint message 714 is described in FIG. 10.

The acknowledgment message 715 sent by the application-server process 703 that includes the backup execution module 710 to the application-server process 702 that includes the associated active execution module 709 is used to inform the application-server process 702 with the active execution module 709 that the checkpoint message 714 has been received.

FIG. 8 illustrates exemplary values of three transactional state items before the execution of an exemplary transaction. FIG. 8 also illustrates that prior to the execution of a transaction, no pre-transaction values are maintained.

FIG. 9 illustrates the same items of the transactional state as FIG. 8, but at the end of the execution of the exemplary transaction. FIG. 9 illustrates that the exemplary transaction changed the value of item A from 10 to 11; did not change the value of item B; removed item C from the transactional state; and created a new item, item D, with the value equal to 40. FIG. 9 illustrates the exemplary bookkeeping of the pre-transaction values 901, which allows the application-server process to restore the transactional state to the pre-transaction values should the transaction fail.

FIG. 10 depicts the content of a checkpoint message 1000 that is sent by the application-server process that includes the active execution module to the application-server process that includes the associated backup execution module. The checkpoint message includes an identifier of the execution module to which the message should be applied 1001 and a description of the changes to the transactional state done by the transaction program 1002 in the active execution module. In FIG. 10, the exemplary checkpoint message indicates that the value of item A was changed to 11; item C was removed; and that item D was created with the value equal to 40.

FIG. 11 is a flow chart illustrating the steps of executing an exemplary transaction. A client (corresponding to Client 1 in FIG. 7) of the transaction processing system submits a transaction request to communication module 1101. Communication module 1101 determines to which execution module the request should be sent. The execution module is the currently active execution module that has the transactional program and the transactional state needed by the transactions. This execution module is referred to as the target execution module 1102. The communication module delivers the transaction request to the application-server process that includes the target execution module 1 103. The application-server process locates the target execution module and the transaction program within the execution module, sets up the context for the execution of the transaction program, and starts the execution of the transaction program 1104. The transaction program then executes. During its execution, the transaction program accesses the transactional state items located in the same execution module 1105. The transaction program can read, modify, remove, or create the transactional state items. While the transaction program executes, the application-server process, transaction program, and runtime artifacts co-operate to achieve the ACID properties during the execution of the transaction. Although the exact distribution of the responsibilities across these parts of the system could be different in different embodiments of the invention, in general, these parts 1106 may ensure that: (a) the pre-transaction values of the transactional state items are maintained such that it is possible to undo the changes made by a failed transaction; (b) multiple transactions that access the same transactional state items do not interfere with each other. Some exemplary methods for synchronizing conflicting concurrent transactions are described below.

If the transaction program completes its execution without a failure 1107, the following commit steps are executed. The application-server process extracts the new values of the transactional state items that have been modified by the transaction and sends a checkpoint message to the application-server process that includes the associated backup execution module (which is referred below as the second application-server process) 1108. The checkpoint message includes the identification of the transactional state items that have been changed, created, or removed by the transaction, and the new (i.e. post-transaction) values of these items. The second application-server process receives the message and applies the state changes to the copy of the transactional state held in the backup execution module 1109. The second application-server process sends an acknowledgment message to the first application-server process indicating that it has received the checkpoint message 1110. The application-server process releases the resources that have been allocated for the current transaction. This release of resources includes the discarding of the records of the pre-transaction values and unblocking the transactions that are waiting for the completion of the current transaction 1111. In some embodiments of this invention, the blocked transactions are unblocked in an earlier step, as it is discussed in detail below. If the transaction request indicates that the client is waiting for a response message, the application-server process sends the client a response message that includes the results returned from the transaction program 1112.

If the transaction program fails during its execution, the following rollback steps are executed. Using the records of the pre-transaction values associated with the transaction, the application-server process restores the transactional state to pre-transaction values 1113. The application-server process releases the resources that have been allocated for the current transaction. This release of resources includes the discarding of the records of the pre-transaction values and unblocking the transactions that are waiting for the completion of the current transaction 1114. If the transaction request indicates that the client program expects a response, the application-server process sends the client program a response message indicating that the transaction has failed 1115.

The steps on the flow chart describe execution of a single transaction. The transaction-processing system can execute multiple transactions over a period of time.

When multiple transactions are executed, each individual transaction is executed in steps including those in flow chart. The transaction-processing system can execute multiple transactions serially or concurrently.

Some embodiments of a transaction-processing system might execute some transactions using the invention but other transactions using a different method not described in this disclosure.

Other embodiments of the methods are also possible. If a transaction fails, no message needs to be sent to the application-server process that holds the backup execution module because all changes to the transactional state in the active execution module have been rolled back and therefore no changes to the state in the backup execution module are necessary. However, some embodiments of the invention might include sending a checkpoint message even when a transaction has failed.

Although in the description of the steps the second application-server process sends the acknowledgment message after it has updated the copy of the transactional state in the backup execution module, the invention allows the acknowledgment message to be sent before updating of the transactional state.

Although in the description of the commit steps the application-server process releases resources after it received the acknowledgment message from the second application-server process, some embodiments of the invention may release the resources before an acknowledgement message is received. Releasing resource earlier usually improves performance because blocked transactions could be unblocked earlier. One possible embodiment that releases resources before a checkpoint message has been received is illustrated in FIG. 13.

If a transaction has not modified any items of the transactional state, the first application-server process does not have to send a checkpoint message to the second application-server process. This is a performance optimization for read-only transactions. Thus, while there are advantages to including a checkpoint message in the steps of executing a transaction, not all transactions require one in different embodiments of the invention.

Synchronizing Conflicting Transactions

When multiple users submit transactions to a transaction processing system, it is possible that several transaction requests arrive at the same execution module at approximately the same time.

Some embodiments of the invention execute the transaction requests arriving at each execution module serially; that is, at any time only a single transaction executes in a given execution module. The transaction-processing system achieves parallelism by executing multiple transactions concurrently in different execution modules. This parallelism is generally possible if the application can be partitioned into multiple execution modules and if the transaction requests can be spread across multiple execution modules.

Some applications of the invention allow transactions to be executed concurrently within a single execution module. Some embodiments of the invention use locks to synchronize multiple conflicting transactions running within a single execution module. In some embodiments, this intra-execution-module transaction parallelism is combined with the transaction parallelism across multiple execution modules to achieve even higher total transaction throughput.

Each item of the transactional state is covered by a lock. In some embodiments of the invention, each item is covered by a unique lock; in other embodiments a single lock covers multiple items (this includes the case that a single lock covers all the transactional state items of an execution module). Before a transaction can read or write a value of the transactional state item, it must obtain an appropriate lock on the item. Some embodiments of the invention use two types of locks: shared and exclusive. A shared lock which is obtained before an item is read. An exclusive lock which is obtained before an item is updated, created, or deleted.

Other embodiments of the invention use only the exclusive type of locks. In these embodiments, an exclusive lock that covers the item must be obtained before an item is read, updated, created, or deleted.

If a transaction attempts to obtain a lock, the lock will be granted only if no other transaction holds the lock in a conflicting mode. The following table defines when a lock could be granted to a transaction as a function of the lock held by another transaction:

| Lock requested | Lock held by another transaction | | |
|---|---|---|---|
| by a transaction | no lock | Shared | exclusive |
| shared | Grant | Grant | conflict |
| exclusive | Grant | Conflict | conflict |

If another transaction holds the lock in a conflicting mode, the transaction that attempts to obtain the lock will wait until the transaction holding the lock has released it.

The point of time at which the locks held by a transaction are released is significant to ensuring ACID properties. Two illustrative methods for releasing locks held by transactions, each using a different approach, are described. The first method depicted by the flow chart in FIG. 12 illustrates a conservative approach—locks are released at the very end of the transaction execution. The second approach depicted by the flow chart in FIG. 13 illustrates a more aggressive approach—locks are released at an earlier time so that they are not held while the transaction waits for a checkpoint acknowledgement message. The second approach increases transaction parallelism within an execution module because other transactions that have been blocked on locks held by a committing transaction might execute while the committing transaction waits for a checkpoint acknowledgement message.

FIG. 12 is a flow chart illustrating the steps for obtaining and releasing locks to synchronize a transaction execution with the execution of other transactions. A client submits a transaction, the transaction is routed via the communication module to the target execution module, and the execution of a transaction program is started 1201 according to the first four steps 1101-1104 of the flow chart in FIG. 11. A transaction program executes and as part of its execution, it accesses the items of the transactional state included in the execution module 1202. The steps in the flow chart depict that before a transaction can read the value 1208 of a transactional state item, it must obtain a shared lock covering the item 1203. Also, before a transaction can write the value 1207 of a transactional state item, it must obtain an exclusive lock covering the item 1204. A transaction must also obtain the exclusive lock covering an item before it can create or remove the item. The flow chart also illustrates that a pre-transaction value of an item is saved before the item is updated or removed 1205. The transaction can perform other actions that do not read or modify the transactional state and therefore do not have to obtain locks before performing these actions 1206.

If a transaction program completes without failure 1210, the Commit Steps 1211-1217 illustrated in the flow chart are executed. The Commit Steps include the following steps. The shared locks held by the transaction are released 1211. This unblocks other transactions that requested exclusive locks conflicting with the shared locks held by the transaction. A test is made whether the transaction is a read-only transaction 1212. A read-only transaction is one that has not modified (i.e. updated, created, or removed) any transactional state items. If the transaction is a read-only transaction, a response message with the results of the transaction program is sent to the client 1217. The execution of the transaction is now complete. If the transaction is not a read-only transaction, the new values of the transactional state items modified by the transaction are extracted and a checkpoint message is sent to the application-server process including the associated backup execution module (which is referred below as the second application-server process) 1213. The checkpoint message includes the identification of the transactional state items that have been changed, created, or removed by the transaction, and the new (i.e. post-transaction) values of these items. The second application-server process receives the message and applies the state changes to the copy of the transactional state held in the backup execution module and sends an acknowledgment message to the first application-server process indicating that it has received the checkpoint message 1214. When the acknowledgment message has been received 1215, the exclusive locks held by the transaction are released 1216. This unblocks other transactions that requested locks conflicting with the exclusive locks held by the transaction. If the transaction request indicates that the client is waiting for a response message, a response message that includes the results returned from the transaction program is sent to the client 1217.

If a transaction program completes with a failure, rollback steps 1218-1220 are executed. The rollback steps include restoring the pre-transaction values 1218, releasing all locks held by the transaction 1219, and sending a failure indication message to the client (only if the transaction request indicated that a response should be sent) 1220.

In some embodiments, the second application-server process stores the checkpoint message, sends a checkpoint acknowledgement message, and then later applies the checkpoint message to the transactional state in the backup execution module. This optimization is done, for example, to reduce the latency of the checkpoint message and its acknowledgment.

In some embodiments of the invention, only exclusive locks are used. In these embodiments, a transaction obtains an exclusive lock covering a transactional state item before it performs any operation on the item (including reading, updating, creating, or deleting the item).

In some embodiments, a transaction releases the shared locks at the same time when it releases the exclusive locks; that is, after it has received the checkpoint acknowledgment message. However, releasing the shared locks earlier is considered generally better for improving transaction parallelism. Some embodiments of the invention may implement hierarchical locking when accessing transactional state items.

The method depicted by the flow chart in FIG. 12 allows transactions with non-conflicting locks to execute concurrently within the same execution module. Some applications might desire to achieve even higher parallelism by increasing the parallelism among transactions with conflicting locks. The main factor limiting the concurrency of conflicting transactions is the network latency between sending a checkpoint message and receiving its checkpoint acknowledgment messages. This is because a transaction normally holds its exclusive locks until the checkpoint acknowledgement message has been received.

Some embodiments of the invention might use an optimization that allows a transaction to wait for the checkpoint acknowledgment message without holding any locks. Not holding locks allows other transactions to execute while the transaction is waiting for the checkpoint acknowledgement message. However, additional synchronization among transactions (in addition to using locks) may be useful to ensure the transaction ACID properties in the presence of failures (see the below notes detailing how the ACID properties could be violated without proper synchronization).

FIG. 13 is a flow chart that includes the steps of one possible embodiment of performance optimization that allows a transaction to wait for a checkpoint acknowledgement message while holding no locks without compromising the ACID properties. The description of the steps follows. A transaction executes according to the same steps as in FIG. 12 until it reaches the Commit Steps. The Commit Steps 1301-1311 in FIG. 13 are different from those in FIG. 12.

If the transaction is a read-only transaction, the following steps are executed. The transaction determines the last previous write transaction (a transaction is a write transaction if it is not a read-only transaction) 1301. The read-only transaction is commit-dependent on the last previous write transaction and does not return a response message to the client until the write transaction has received a checkpoint acknowledgment message. The read-only transaction releases all its locks 1302. This unblocks other transactions that requested locks conflicting with the locks held by the transaction. The read-only transaction waits until the write transaction associated on which the read-only transaction is commit-dependent has received a checkpoint acknowledgement message 1303. If the transaction request indicates that the client is waiting for a response message, a response message that includes the results returned from the transaction program is sent to the client 1304.

If the transaction is not a read-only transaction (i.e. it is a write transaction), the following steps are executed. The transaction is assigned a commit sequence number 1306 and transaction is remembered as the last previous write transaction 1305 for the purpose of establishing commit-dependency by subsequently committing read-only transactions.

The commit sequence number is used to ensure that the checkpoint messages are applied in the proper order to the backup execution module. In some embodiments, the commit sequence numbers are monotonically increasing integers (i.e. 1, 2, 3, etc.). The transaction releases all its locks 1307. This unblocks other transactions that requested locks conflicting with the locks held by the transaction. The new values of the transactional state items that have been modified by the transaction are extracted and a checkpoint message is sent to the application-server process that includes the associated backup execution module (which is referred below as the second application-server process) 1308. The checkpoint message includes the identification of the transactional state items that have been changed, created, or removed by the transaction, the new (i.e. post-transaction) values of these items, and commit sequence number. The second application-server process receives the checkpoint message and applies the state changes to the copy of the transactional state held in the backup execution module. 1309 The second application server applies the received checkpoint messages in the commit sequence order. Processing the checkpoint messages in the commit sequence number order is necessary to ensuring the ACID properties (see the notes below). The second application-server process sends an acknowledgment message to the first application-server process indicating that it has received the checkpoint message 1309. When the checkpoint acknowledgment message has been received 1310, all the read-only transactions that are commit-dependent on this write transaction are notified so that they can complete 1311. If the transaction request indicates that the client is waiting for a response message, a response message that includes the results returned from the transaction program is sent to the client 1304.

It is apparent from the flow chart that a read-only transaction does not send a response message to a client until the checkpoint message of the write transaction on which the read-only transaction is commit-dependent has been applied to the backup execution module. This wait step is important for avoiding a violation of the ACID properties that could happen if the read-only transaction did not wait for the write transaction to receive a checkpoint acknowledgement message. A scenario leading to ACID violation would be:

Client A sends a write transaction request.

The write transaction changes a value of a transactional state item.

Client B sends a first read-only transaction request.

The first read-only transaction reads the new value of the item.

The first read-only transaction sends the value to its client without waiting for the write transaction to receive its checkpoint acknowledgement message.

Client B receives the new value.

The application-server process including the active execution module fails before it managed to send the write transaction's checkpoint message to the second application-server including a backup execution module.

Client B repeats the read-only transaction request.

The transaction-processing system routes the request to the execution module in the second application-server process that was previously in the backup role but now it is in the active role.

The read-only transaction returns the old value of the item.

Client B receives the old value.

From the perspective of Client B, this scenario appears as a “lost update”. The first read-only transaction reads a new value written by the write transaction, but the second read-only transaction read the old value. The value written by the write transaction got lost as the result of the failure and thus is a violation of the ACID properties.

It is sufficient that a read-only transaction waits only for the checkpoint acknowledgment message of the last previous write transaction in order to allow the values of all the transactional state items accessed by the transaction to be checkpointed to the backup execution module. As the checkpoint messages are applied to the backup execution module in the commit sequence number order, when a checkpoint message of the last previous write transaction is applied, it is understood that the checkpoint messages of all the previous write transactions have been already applied.

Achieving Exactly-Once Semantics for Transaction Request Execution

In the absence of failure, a user transaction request is routed to the transaction program in the active execution module. The transaction program is then executed. If the transaction updated any transactional state, a checkpoint message is sent to the backup execution module; and a response message is sent to the user. In this case, the transaction request was executed once and only once.

If the active execution modules fails (for example because of a hardware failure) while executing the transaction program, in general, the transaction processing system does not know if a checkpoint message has been sent to the backup execution module or not. In some embodiments, if such a failure occurs, the transaction processing system sends an error response to the user, the error response indicating that there was a failure and that it is unknown whether the request completed or not. The transaction processing system cannot automatically retry by sending the request to the backup execution module (after the backup execution module has been enabled) because if the request has been processed before the failure, it would be incorrect to process it again.

The above error execution semantics are called “at-most-once”. While the at-most-once semantics are acceptable in many embodiments, in other embodiments it might be desirable to provide “exactly-once” semantics. The exactly-once semantics simplify the users view because if the user receives an error message, the user is sure that the request has not been processed.

Some embodiments of the transaction processing system achieve “exactly-once” semantics by the following technique. When a transaction program in the active execution module completes, it prepares a response message to be sent to the user. If the transaction program has modified at least one transactional state item, a checkpoint message is sent to the backup execution module. The checkpoint message includes a “transaction execution record”, the transaction execution record including an identifier of the transaction request and the content of the corresponding response message. The transaction execution record is also saved in the active execution module. The transaction execution record is then saved in the backup execution module. If the active execution module fails before sending the transaction program sends a response message to the user, the transaction processing system re-submits (typically this is done by the communication module) the original transaction request to the backup execution module (which has been promoted to “active” role after the failure). Finally, before the transaction program in the backup execution module is dispatched, the transaction processing system checks if the transaction execution record corresponding to the requests exists in backup execution module. If it exists, the response message stored in the record is sent to the user without dispatching the transaction program.

The above algorithm ensures that a transaction request that modified at least one transactional state item will not be executed more than once. If the transaction program has not modified any transactional state item, the transaction program might be executed more than once. This is considered safe because the first execution of the transaction program has not modified any items, making it indistinguishable from not executing the transaction program the first time at all.

In some embodiments, the transaction execution records are removed from the execution modules after a specified timeout. In other embodiments, the transaction execution records are removed from the execution modules in response to a message received from the user indicating that the user has received the response message. In some embodiments, this indication is piggybacked on the user's next transaction request to minimize the number of messages.

Synchronizing External Database with Transactional State

As noted previously, one idea of the invention is that an application's transactional state is closely integrated with the transaction program. This allows transactions to be processed without incurring the overhead of accessing a database management module and converting the transactional state between different representations.

In some online transaction processing system environments, it may be desirable that data residing in a database management system (DBMS) separate from the transaction-processing system be kept synchronized with the transactional state maintained within the transaction-processing system.

There are several reasons for such a synchronization. For instance, parts of the transactional state may become inactive over time and therefore could be moved from the online transaction-processing system into a separate database used for archiving past transactions. Moving of the transactional state to database frees the application-server process's memory occupied by the inactive transactional state. Also, parts of the transactional state can be made available to other applications, such as complex query applications or other transaction processing systems. Therefore, the data in the database used by the query applications can be synchronized with the transactional state residing in the application's execution modules. Lastly, some users believe that data stored on disks is more resilient to data loss than data stored in replicated computer memories. Therefore, users may require that the changes to the transactional state be periodically reflected in a disk-based database for the purpose of failure recovery.

An example of when a synchronization might be useful is when an online auction completes. In this case, the auction's final state could be removed from the online transaction-processing system and kept in a database that archives completed auctions. In another embodiment of the invention, the system can be configured such that the database will be updated each time the state of an auction has been changed in the transaction-processing system.

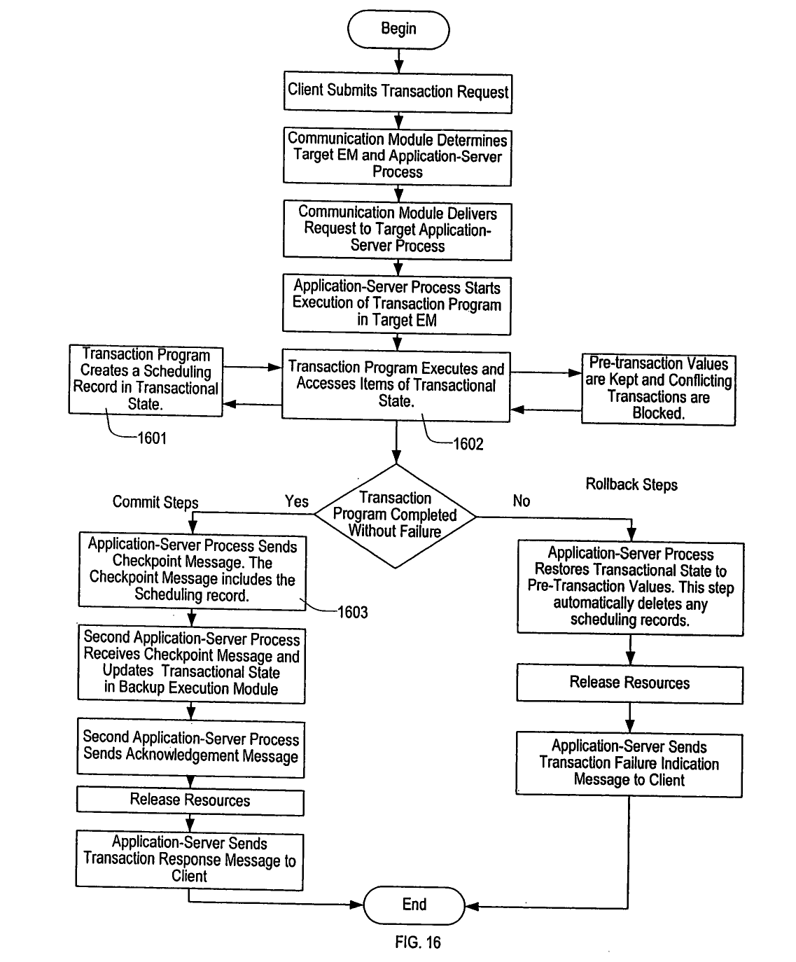

The present invention includes a method for synchronizing data in an external database with the changes to the transactional state. FIG. 14 illustrates the main components involved in the database synchronization method, and FIG. 15 is a flow chart with steps performed during the synchronization. FIG. 16 then illustrates an alternative method of synchronizing data in an external database with changes to the transactional state.

The synchronization is performed without compromising continuous availability of the transaction-processing system. This means that a failure or unavailability of the database management system will not result in the unavailability of the transaction-processing system to its users.

FIG. 14 is one embodiment of the present invention. The application-server process, transaction program, and transactional state objects are the same as described earlier in this document. The objects in FIG. 14 that have not been described yet are as follows. A database module (database) 1401 is a structured collection of data items managed by a database management module. Implementations of the database module 1401 include a database stored on one or more disks. Implementations of the database management module 1403 include a database management system. Synchronized items 1402 are the data items in the database that are updated or created by database synchronization transactions. Database management module 1403 is a database management system that manages the database that is subject to the synchronization with the transactional state. Database synchronization transaction 1404 is a database transaction (not to be confused with the normal use of the term transaction in this document) originated by the application-server process that updates or creates some items in the database in response to the transactions committed in the transaction-processing system.

A trigger is an association between a transaction program and a database synchronization program. The trigger may be implemented with trigger logic. A trigger instructs the application-server process 1405 to schedule the execution of the database synchronization program 1406 after the associated transaction program has completed. The database synchronization program 1406 could be executed immediately after the associated transaction program commits, or after some delay. In some embodiments of the invention a trigger is included in the transaction program. In other embodiments, it is included in the runtime artifacts.

A scheduling record is the information maintained by the transaction processing system specifying that a database synchronization program needs to be executed. In some embodiments of the invention, the scheduling records are maintained as items of the transactional state, but in other embodiments they might be stored the differently.

A database synchronization program 1406 is a program or logic that includes the instructions for many characteristics. The database synchronization program 1406 may read the values of some or all of the items of the transactional state. It may also execute a database synchronization transaction that creates or updates some items in the database using values derived from the values of the transactional state read in the previous step. It may further remove or update some items of the transactional state. These instructions are optional and a database synchronization program includes them only if some items of the transactional state are no longer needed or need to be updated after the execution of the database synchronization transaction. An example would be an online auction application where, after the database has been updated with the result of an auction, the auction state can be removed from the online transaction processing system.

Different embodiments of the invention use different ways of including the trigger, scheduling record, and database synchronization program. In some embodiments of the invention, they are created by the application programmer and are essentially a part of the application. In other embodiments, they are created by application-development or deployment tools. In the latter case, they are typically included in the runtime artifacts but other embodiments are possible. In yet other embodiments of the invention, they are included in an object-relational mapping logic used by the application-server process.

FIG. 15 is a flow chart that includes the modifications of the steps in the flow chart in FIG. 11 that are necessary to schedule a database synchronization transaction. In this embodiment of the invention, the presence of a trigger is tested after the transaction program completes. The steps are illustrated in FIG. 15 and are as follows. A transaction program executes as described by the first six steps in FIG. 11 1501. If the transaction program terminates with a failure, the rollback steps described in FIG. 11 are executed 1502. If the transaction program terminates without a failure, a check is made if there is a trigger associated with the transaction program 1503. If there is no trigger, the transaction commit steps are executed as described in FIG. 11 1504.

If there is a trigger associated with the transaction program, a scheduling record is created to indicate that the associated database synchronization program needs to be executed 1505. In one embodiment of the invention, the scheduling record is recorded in the transactional state. Recording the scheduling record in the transactional state has an advantage that scheduling of the database synchronization program survives a failure of the active execution module because the scheduling event will be automatically propagated in the checkpoint message to the backup execution module. The database synchronization program in some embodiments is not executed as part of the ordinary transaction program that has triggered it, because doing so could adversely affect performance and availability of the transaction processing system. After the scheduling record of the database synchronization program has been made, the transaction commit steps proceed as described in FIG. 11 1504. It should be noted that if the scheduling of the database synchronization program has been recorded in the transactional state, the information is included in the checkpoint message and is thereby propagated to the backup execution module.

In the steps of the flow chart in FIG. 15, the check for the presence of a trigger and the creation of scheduling records is made after the transaction program has completed its execution. This approach is useful for embodiments of the invention in which it is desirable to add database synchronization transactions to a transaction program after the transaction program has been previously written without consideration for database synchronization.

In other embodiments of the invention, the transaction program may create the scheduling records during its execution (i.e. before the transaction program completes). In these embodiments, the trigger and the creation of the scheduling records are implicitly included in the transaction program itself, or are included in the runtime artifacts. This alternative method is depicted by the steps in the flow chart in FIG. 16. The steps in the flow chart in FIG. 16 are similar to the steps in the flow chart in FIG. 11, with the following differences.

A transaction program creates database scheduling records 1601 while it executes and accesses the transactional state items 1602. In some embodiments, the database scheduling record is represented by some information included in the transactional state, such as by a value of a transactional state item or by the existence of a transactional state item. The checkpoint message includes the description of the scheduling records 1603 so that they could be reflected in the state of the backup execution module included in the second application-server process.

After the transaction program that created a scheduling record completes, an associated database synchronization program will be executed. The database synchronization program can either be executed immediately after the transaction program has completed, or after some delay.

In some embodiments of the invention, the execution module includes a background thread that periodically looks for new scheduling records and executes their associated database synchronization transactions. In other embodiments, the background thread is included in the application-server process. In yet other embodiments, the background thread is included in the runtime artifacts that were generated by tools.

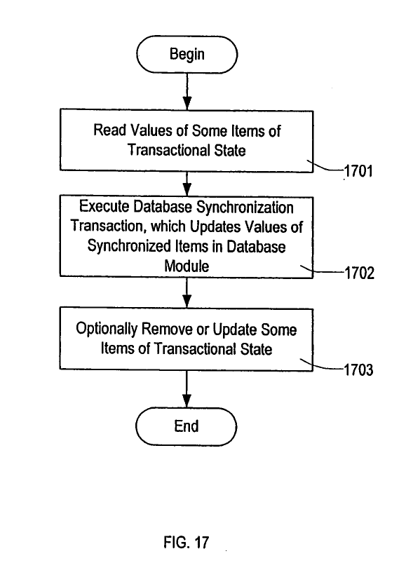

FIG. 17 is a flow chart showing the steps of the execution of a database synchronization program. The database synchronization program reads the values of the relevant items of the transactional state 1701. Typically, the read values include the values of the items that have been changed by the transactional program that triggered the database synchronization program. This step is executed as a transaction, which is a read-only transaction not requiring a checkpoint message, to ensure that the read values of the transactional state are mutually consistent. The database synchronization program executes a database synchronization transaction 1702. One of the advantages of a method of the invention is that the database synchronization transaction does not block clients' transactions executing in the transaction-processing system. After the database synchronization transaction has completed, the optional instructions for removing or updating parts of the transactional state (if the database synchronization program includes these instructions) are executed 1703. The instructions that update or remove some items of the transactional state are executed using the steps of the flow chart in FIG. 11, however without any communication with a client.

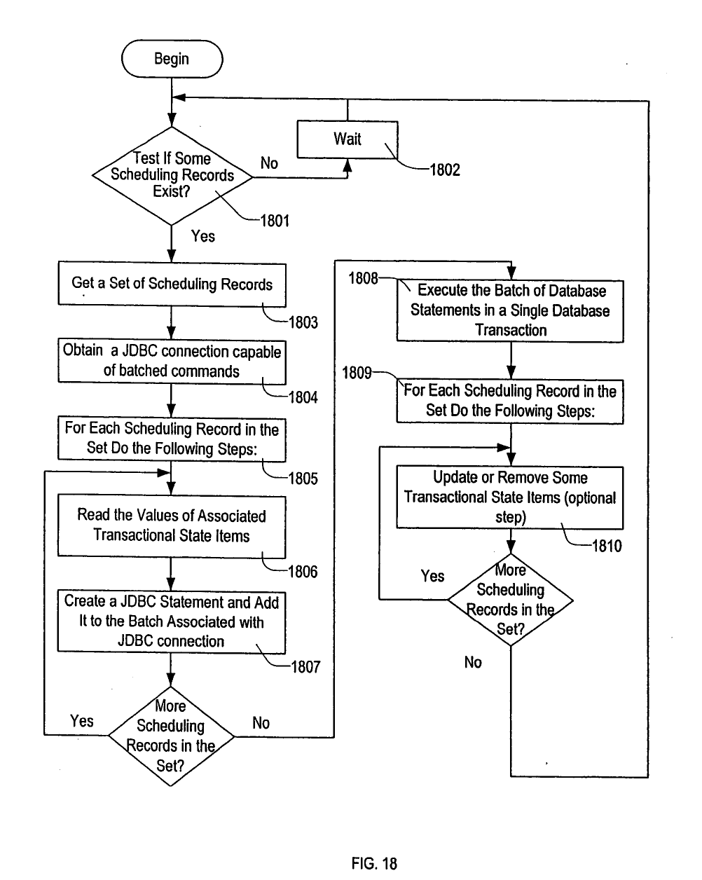

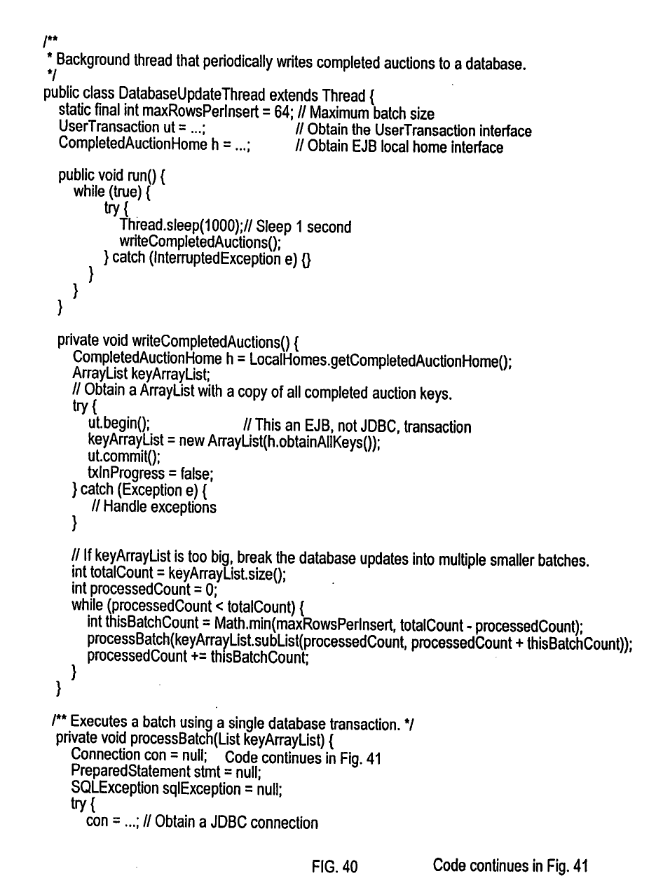

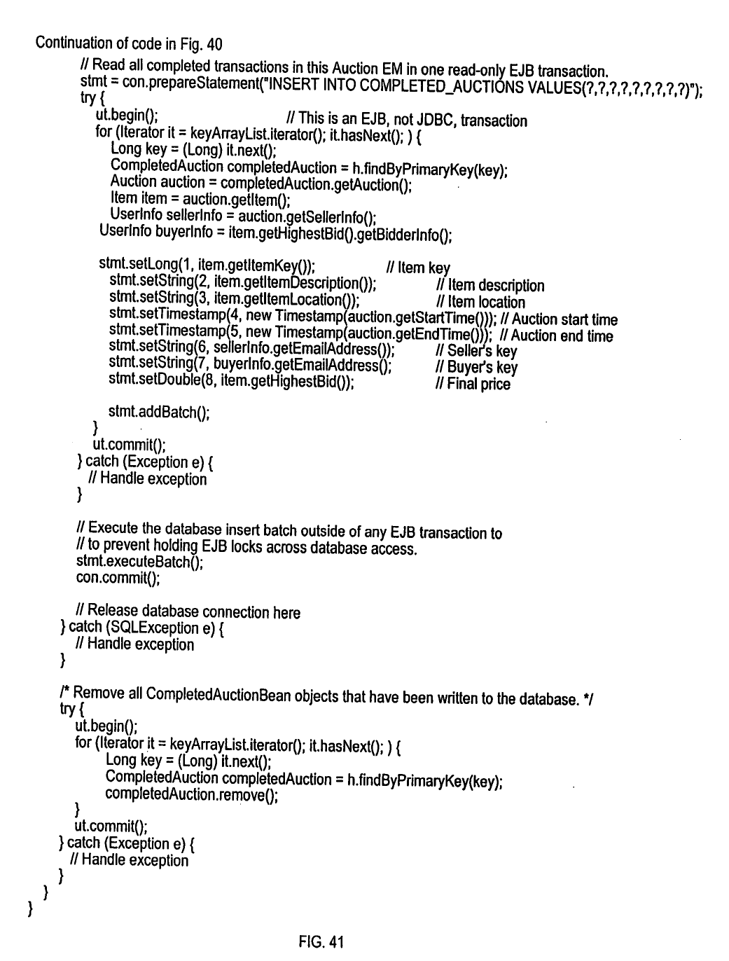

To improve performance, the application-server process can defer the execution of the database synchronization program and combine the work on behalf of multiple scheduling records into a single database transaction. This optimization avoids having to execute multiple database transactions, each of which would consume time and resources. An example embodiment of this optimization is depicted in the flow chart in FIG. 18 and in the Java code in FIGS. 40 and 41.

Delaying the execution of a database synchronization program can improve performance of accessing “hot spot” items in the transactional state. A hot spot is a transactional state item that is updated very frequently. Delaying a database synchronization program will result in performing a single database synchronization transaction for multiple transactions that have updated the same hot-spot item.

One possible embodiment of a database synchronization transaction is a database transaction that includes one or more SQL statements and/or stored database procedures.

While we use the terms “database management module”, “database module”, and “database transaction” in the description of the invention, a method of the invention applies to any external information processing system whose state needs to be synchronized with the transactional state. There are many possible embodiments of an information processing system. For example, in some embodiments of the invention, the external information processing system is another transaction processing system. In other embodiments of the invention, the external information processing system is an Enterprise Resource Planning (ERP) system.

The flow chart in FIG. 18 illustrates an embodiment of performance optimization that allows a single database transaction to include database updates associated with multiple scheduling records. In some embodiments, the steps of the flow chart are executed by a background thread included in the application-server process. The description of the steps follows. The thread tests whether some database synchronization records exist 1801. If none exists, the thread waits for a period of time, or until notified that some scheduling records have been created 1802. If some scheduling records exist, the thread gets a set of scheduling records 1803. The set may include all or only some of the scheduling records.

The thread obtains a database connection 1804. In some embodiments, the database connection is a Java Database Connectivity (JDBC) connection capable of batch updates. In other embodiments, an Open Database Connectivity (ODBC) connection is used. For each scheduling record in the set, the thread performs the following steps 1806-1807. Read the values of transactional state items associated with the scheduling record 1806. Using the read values of the transactional state items, it creates a database update statement and adds it to a batch of statements associated with the database connection 1807. In some embodiments, this is accomplished by using the JDBC batch update capability. Execute all the update statements in the batch in a single database transaction 1808. The database transaction updates items in the external database. When the database transaction completes, for each scheduling record in the set 1809, the thread updates or removes some items of the transactional state to reflect the fact that the items in the database have been synchronized with the corresponding items of the transactional state 1810. This step is optional and is skipped in some embodiments of the invention.

In some embodiments of the invention, a single read-only transaction of the transaction-processing system is used to read the values of the transactional state items on behalf of all the scheduling records in the set. In other embodiments of the invention, a single write transaction of the transaction processing system is used to execute the update and/or remove operations associated with all the scheduling records in the set.

Synchronizing Transactional State with External Database

In some embodiments of the invention, it may be desirable that some items of the transactional state be synchronized with data items located in an external database. There are several reasons for this synchronization and include the following. First, the total size of the transactional state kept in the online transaction-processing system is too large to be kept economically online at all times. Therefore, it is desirable that the transaction-processing system be able to deactivate some transactional state items by moving them to an external database (for example by using database synchronization transactions described earlier in this invention). When a transaction needs to access an item of the transactional state that is not present in the online transaction processing system because it has been moved to an external database, the transactional state item must be re-created from the information in the external database before the transaction can access the item. Also, the transactional state is derived from data items located in an external database and applications other than those running on the transaction processing system might modify the data items in the database. It is often desirable that the transactional state items be synchronized with the changed items in the database.

An example of the first reason is when a user wants to view the bids on an auctioned item whose state has been moved to an external database because the auction has been inactive for a long time. The transactional state items including the auction and its bids must be reconstructed from the information in the database when processing the user's transaction.

An example of the second reason is when a transactional state item includes information about a user (such as address and phone number) which has been originally read from an external database. Since another program might change the address and phone number in the database, it might be desirable to update the transactional state so that it includes up-to-date user information.

The term “database read transaction” means a database transaction that reads the values of some items included in an external database with the purpose of creating or updating some items of the transactional state whose values are based on the values of the items read from the database.

Reloading Deactivated Transactional State from External Database

This method has advantages over the methods of prior art when some transactional state items that were previously moved to an external database are needed for the execution of later transaction.

In the methods according to prior art, a transaction starts, accesses some transactional state items, and then discovers that it needs to access additional transactional state items that are not currently present in the execution module and must be created by reading some data items in an external database. This scenario results in a performance problem in the prior art systems because the transactions reading the values of items in the database hold locks on the items of the transactional state that have been accessed so far and these locks block other transactions. As the database read transactions are typically long operations compared to the transaction of the transaction-processing system (they can take by a factor of 100-1,000 longer), the presence of the database read transactions may significantly reduce the overall transaction throughput of the transaction-processing system.

One of the advantages of the method of this invention is that other transactions are not blocked during the execution of a database read transaction. The method depicted in the flow chart in FIG. 19 avoids holding locks while performing database read transactions by aborting the in-progress transaction and dropping its locks before that transaction performs a database read transaction. When the database read transaction completes, the aborted transaction will be restarted from the beginning. The restarted transaction will access the transactional state items that have been created from the information in the database.

The overhead of aborting and retrying a transaction is much smaller than the overhead of performing a database read transaction. Therefore, aborting and retrying a transaction does not create a performance problem.

FIG. 19 depicts the steps of a method of the invention. The steps of a client submitting a transaction request 1901, the target execution module and application-server process are determined 1902, the request is delivered to the target application-server 1903, and the application-server process starts execution of a transaction program 1904 are the same as the steps in the flow charts in FIG. 11. The method described in FIG. 19 includes an additional step in which it is determined whether an item of the transactional state needed by the transaction is missing 1905. This test for a missing transactional state item might be included in the application or in the runtime artifacts. If a transactional state item required by the transaction program is missing, the transaction proceeds according to the steps in the flow charts in FIG. 12 or 13 (which one depends on whether the optimization of releasing locks before checkpoint acknowledgement is received is desired or not).

If a transactional state item required by the transaction is missing, the following steps are executed. The in-progress transaction is aborted by restoring the values of the transactional state items that have been modified by the transaction to their pre-transaction values 1906. The locks held by the transaction are released 1907. This unblocks other transactions waiting on those locks. A database read transaction is performed to read the values of some data items from the database 1908. The missing item of the transactional state is created by using the values of data items read by the database read program 1909. The transaction program is then restarted from the beginning.

There are also other items relating to the method described in FIG. 19. First, the transaction program holds no locks on the transactional state while it executes the database read transaction. Second, in some embodiments, the missing items of the transactional state are created by using a normal transaction of the transaction-processing system depicted in the flow chart in FIG. 11. This enables the missing items to be created also in the backup execution module. Third, in some embodiments, a transaction program might perform several database read transactions before it completes. This would happen if the program encountered missing transactional state items more than once during its execution. Each time, the transaction program would be aborted; database read transaction executed; missing items created; and the transaction program restarted according to the steps in the flow chart. Fourth, in some embodiments, when a missing transactional state item is being created, other items are created at the same time. For example, when the Auction object is created in the transactional state, all the Bid objects associated with the Auction object are created at the same time by using a single database read transaction. This “read-ahead” optimization is performed because it is anticipated that the Bid objects will also be used by the transaction that reads the Auction object. This performance optimization avoids the repeat transaction aborts described by the previous note. Fifth, in some embodiments, the programming-language's exceptions mechanism is used to abort the transaction and rewind its in-progress execution to the starting point. In these embodiments, the transaction object might include the identity of the missing transactional state items so that they could be passed to the database read transaction.

Synchronizing Transactional State with External Database by Using Database Trigger

In some embodiments of the invention, the values of some transactional state items in the transaction-processing system are derived from the values of data items in an external database. In such embodiments, the values of the data items in the database might be updated by logic other than by the programs in the transaction-processing system (for example, they could be updated directly by a Structured Query Language (SQL) statement). In many applications of the invention, it is desirable that when the values of the data items in the database are updated, the values of the corresponding transactional state items are also updated so that the transaction programs in the transaction-processing use up-to-date values. The advantages of the method described below over prior art include allowing transactions to use up-to-date values without causing the transactions to access the database.

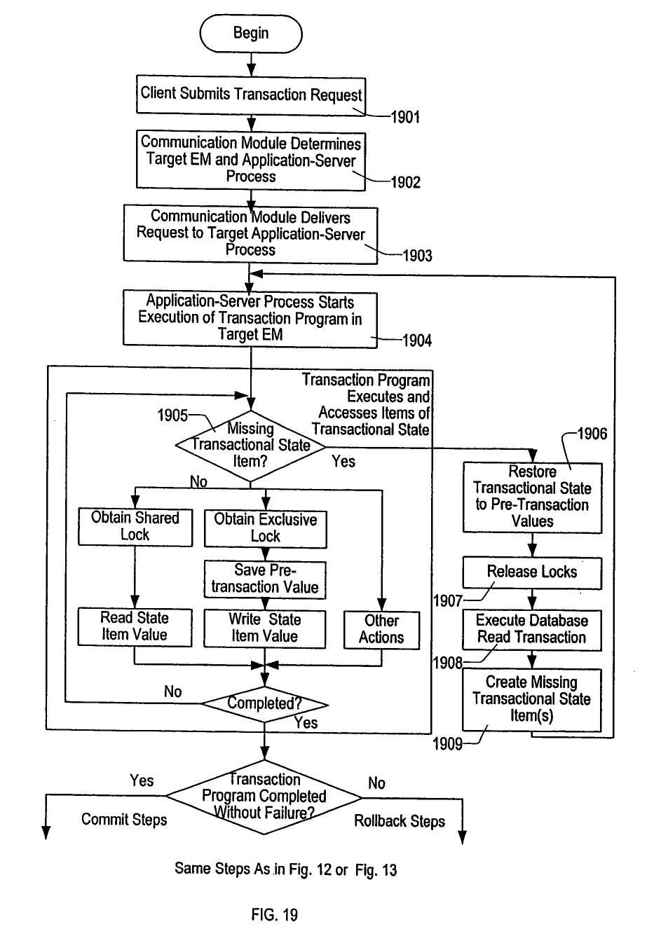

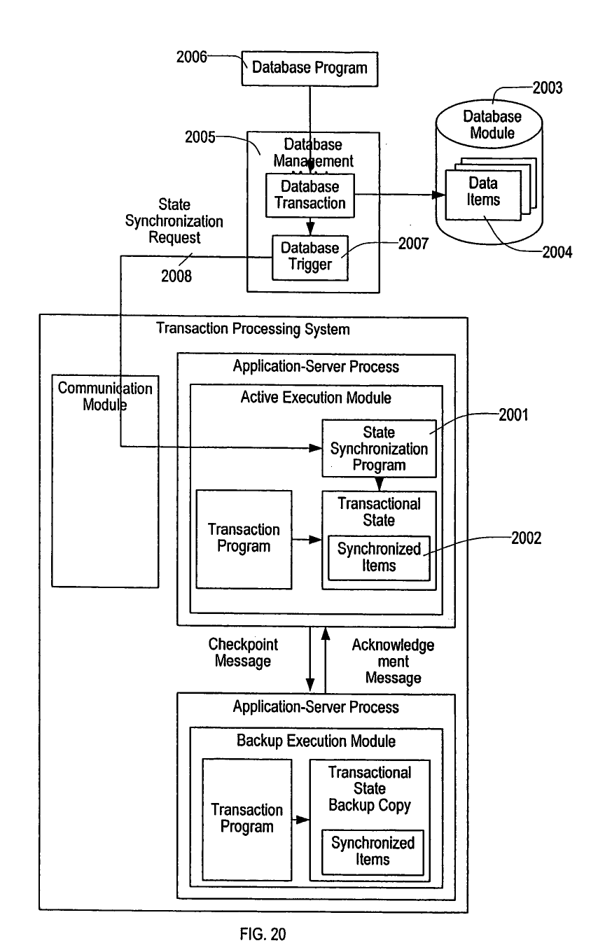

A system for synchronizing a transactional state with data items in an external database by using a database trigger is depicted by the diagram in FIG. 20. The system is the same as the one depicted in FIG. 7, with additional parts including the parts below. A state synchronization program 2001 is a transaction program that differs from other transaction programs because it is invoked by a database trigger rather than by a client program. Synchronized items 2002 are the items of the transactional state whose values are derived from the values of some data items in the database. A database is a structured collection of data items managed by a database management system 2003. Data items are items included in the database 2004. The data items could be updated by a database program running outside of the transaction-processing system. A database management module 2005 includes a database management system that manages the database. A database program 2006 is a program that updates one or more data items in the database and executes outside of the transaction-processing system. A database trigger 2007 is a program associated with data items that is triggered (i.e. it starts executing) each time the values of the data items are changed. A state synchronization request 2008 is a transaction request sent by a database trigger to a state synchronization program.

The steps in the flow chart in FIG. 21 depict a method of how a database trigger is used to initiate a transaction in the transaction-processing system that synchronizes values of some transactional state items with the values of the data items in the database. A database program updates, creates, or removes some data items in the database using a database transaction that executes within the database management module 2101. If a database trigger is associated with a changed data item 2102, the database trigger is executed at the completion of the database transaction. The database trigger sends a state synchronization request to the transaction processing system 2103. The state synchronization request is handled by the transaction-processing system as any other transaction request submitted by an external client. It is routed to the active execution module that includes the target transaction program, which in this case is the state synchronization program, and the transactional state that needs to be updated by the transaction 2104. These steps are the same as the first four steps in FIG. 11. The state synchronization program then executes in a fashion similar to the remaining steps in FIG. 11. During its execution, the state synchronization program updates the values of the synchronized items by using the new values of the data items in the database 2105. Updating the values of synchronized items might include creating and removing some items. The state synchronization program completes and is committed (or rolled back) 2106 according to the steps of the flow chart in FIG. 11, or one of its alternatives in FIG. 12 or FIG. 13.

There are several advantages of the above method including the following. First, the values of the transactional state items are kept synchronized with the values of the data items in the database. Second, the transaction-processing system is available (i.e. it can continue processing clients' transactions) even if the database is offline. Third, the transactions executing in the transaction-processing system do not need to access the database in order to ensure that the values of the transactional state items that they access are up-to-date.

In the specification and claims “creating, modifying and/or removing” means “at least one of creating, modifying and removing.” Also, “updating, creating and/or removing” means “at least one of updating, creating and/or removing.”

Synchronizing Transactional State with External Database by Polling

This method is a minor variant of the method that uses a database trigger. This modified method could be used in the embodiments in which the transactions executed in the transaction processing system can tolerate using slightly out of date (for example by seconds) values of the transactional state items derived from the items in an external database.

In this modified method, a database trigger is not used. Instead, the state synchronization program periodically checks (i.e. polls the database) whether the values of the data items in the database changed. If the values changed, the state synchronization program updates the values of the synchronized items using the last previous values read of the data items.

Starting Transaction-Processing Applications

In some embodiments of the system and method of the invention, when a transaction-processing application is started, the values of some items of its transactional state must be initialized from some data items in an external database.

In one embodiment of the invention, a transaction-processing application is started including the following steps. The execution control system creates the application's execution modules and assigns them to application-server processes. The execution modules include an implementation of the “start” operations. The execution control system invokes the “start” operation on the execution modules, passing it a parameter that indicates the reason for starting the execution module. The values of the reason parameter include APPLICATON_START, RESTART_AFTER_STOP, RESTART_AFTER_FAILURE, PROMOTE_TO_ACTIVE and UPGRADE.

APPLICATON_START indicates that the execution module has been created because the application is being started the very first time (as oppose to being restarted after having been stopped or after it has failed). RESTART_AFTER _STOP indicates that the execution module has been previously stopped and now is being restarted. RESTART_AFTER_FAILURE indicates that the execution module is being re-started after a previous failure of an active and all its associated backup execution modules. PROMOTE_TO_ACTIVE indicates to a backup execution module that it is being promoted to active. UPGRADE indicates that this execution module is a new version of another execution module included in the transaction processing system. A new version of the execution module may include a new version of the transaction programs, runtime artifacts, and the format of the transactional state (the format is called “schema” in some embodiment).

The execution module may take advantage of the “start” operation for initializing some items of its transactional state from the values of data items in a database. The execution module may take advantage of the “reason” parameter to determine whether it is necessary to read the values from database or not. For example, in many embodiments of the invention, if the “start” operation of an execution module is invoked with the PROMOTE_TO_ACTIVE, the execution module does not need to read any values from the database because the values of its transactional state items are updated by checkpoint messages sent from an active execution module to its backup execution modules. The execution control system enables routing of transaction requests to the execution module. The implementation of the “start” operation might be included directly in the transaction-processing application or in the runtime artifacts.

Stopping Transaction-Processing Applications

In some embodiments of the system and method of the invention, before a transaction-processing application can be stopped, the values of some items of its transactional state must be saved as data items in an external database. These data items could be used, for example, to initialize values of the application's transactional state items when the application is later restarted.

In one embodiment of the invention, a transaction-processing application is stopped with steps including the following. The execution modules include the implementation of a “stop” operation. The execution control system disables the delivery of clients' transaction requests to the application execution modules. The execution control system invokes the “stop” operation on the execution modules. In some embodiments of the invention, the “stop” operation includes a parameter indicating the reason for stopping the execution module. In some embodiments, the values of the “reason” parameter include APPLICATION_STOP and UPGRADE.

APPLICATION_STOP indicates that the execution module is being asked to stop because the application including the execution module is stopping. UPGRADE indicates that the execution module is being stopped because it will be upgraded to a new version.

The execution module may take advantage of the “stop” operation to save the values of all or some of its transactional state items in a database. The application might use the saved values when it is restarted in the future. One possible way to save the values of the transactional state items is by using the steps in the flow chart depicted in FIG. 17. After the execution of the “stop” operation has completed, the execution control system might remove the execution module from the transaction-processing system.

Recovering Transactional State from Multiple Failures

The transactional state of applications is protected against single failures by keeping a copy of the transactional state of active execution modules in associated backup execution modules. Although it is very unlikely, it is possible that both an active and all its associated backup execution modules will fail at the same time. In such a case, the values of transactional state items have been lost and the transaction requests directed to the execution module cannot be executed.

In some embodiments of the invention, it is possible to recover the values of all or some lost transactional state items by using values of data items in a database. In some embodiments of the invention, the method described in the section describing synchronizing external database with transactional state is used for synchronizing the data items in a database with the transactional state items prior to a failure.

In some embodiments of the invention, the method for starting a transaction-processing application described in the section describing starting transaction-processing applications is used for restoring the values of the transactional state items from the values of data items in a database after a failure.

The techniques described above are applicable not only to the recovery of a single execution module, but also to the recovery of multiple execution modules, and to the recovery of all execution modules of all applications included the transaction-processing system.

Upgrading a Transaction-Processing Application

The invention may be used with transaction-processing applications that cannot afford any planned or unplanned downtime. Planned downtimes include downtimes caused by upgrading transaction-processing applications to a new version. It is desirable that a running transaction-processing application could be upgraded without making the application unavailable. This upgrading may alter the format of the transactional states.

A method for upgrading a transaction-processing application without making the application unavailable includes the following steps. An old version of the application is executed. Its execution modules include an old version of the transaction programs. New execution modules are created. They include the new version of the transaction programs.

For each old execution module, steps including the following are performed. The transaction requests routed to the old execution module are suspended (temporarily blocked). The “stop” operation in the old execution module is invoked with the UPGRADE reason parameter indicating that the execution module is stopped because of application upgrade. The “start” operation in the new execution module is invoked with the UPGRADE reason parameter indicating that the execution module has been started because of application upgrade. The “start” operation includes an additional parameter, which is an interface allowing the new execution module to access the values of the items of the transactional state in the old execution module. The implementation of the “start” operation uses the passed interface to access the values of the items of the transactional state in the old execution module and uses the values to create the transactional state items in the new execution module. After the new execution module has created its transactional state items, the new execution module is enabled for receiving transaction requests from a client. The suspended transaction requests are unblocked and routed to the new execution module.

There are other attributes for the inventions. In some embodiments of the invention, if an application has multiple execution modules, they are all upgrade at the same time. In other embodiments, the execution modules are upgraded one at a time. In some embodiments of the invention, the application-server process automatically copies the values of the transactional state items from the old to the new execution module as a convenience to the applications. In these embodiments, the “start” operation in the new execution module does not have to copy the state described above. In some embodiments, if the application-server copies the transactional state from the old to the new execution module, it may perform some conversion on the state, such as automatically converting between the types used in the old and new execution modules (for example, an item that was of type “short” in the old execution module might be of type “long” in the new execution module). Although, the description of the invention use the “start” and “stop” operation with the “UPGRADE” reason for the callbacks invoked during the upgrade, other embodiments of the invention may use different operations, such as an “upgrade” operation for handling the callbacks.

Description of Embodiments of the Invention

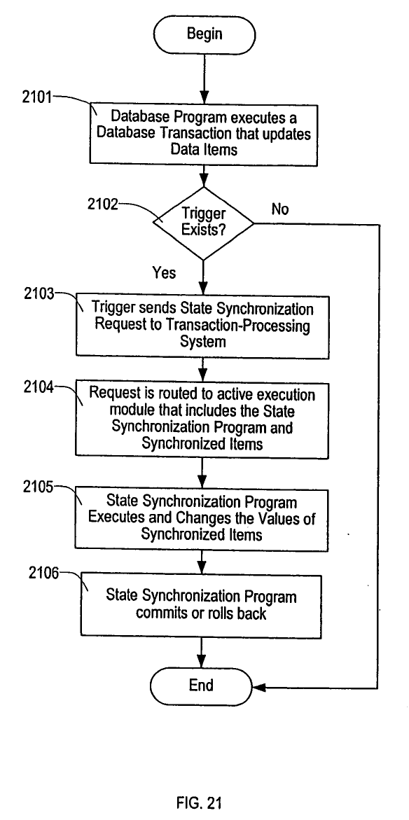

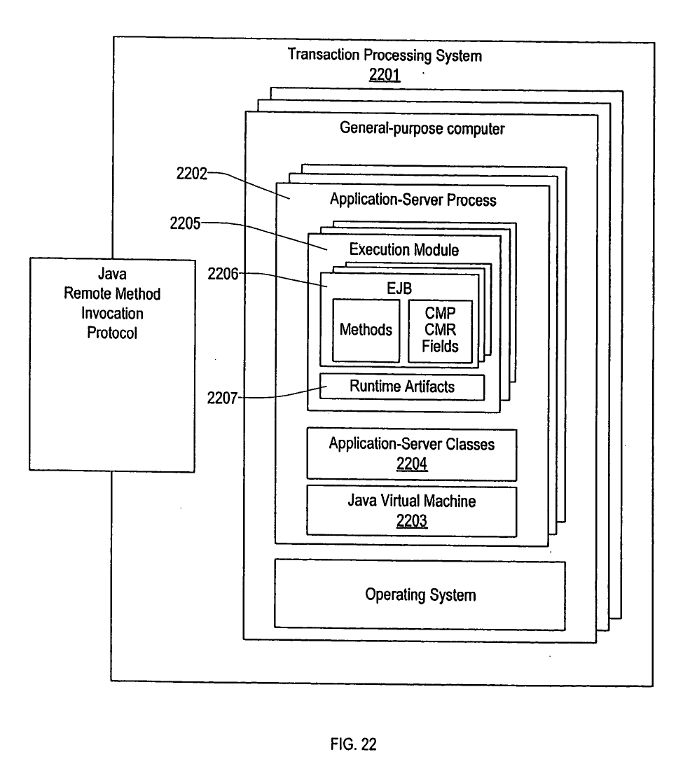

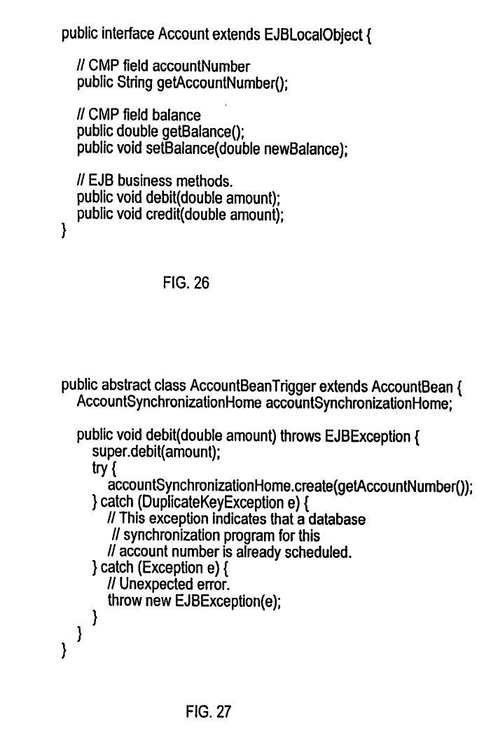

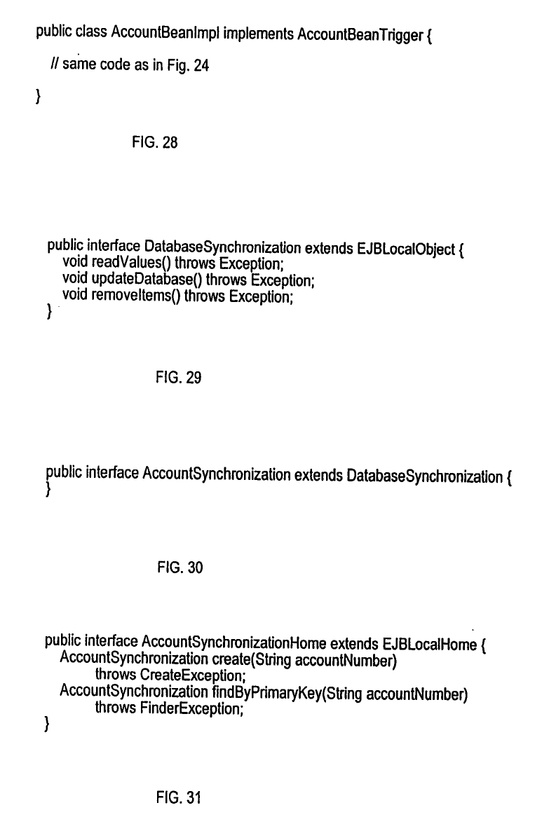

FIG. 22 illustrates an embodiment of the invention. The system includes a transactional processing system 2201 that includes at least two hardware modules. It also includes a Hardware module that is implemented with a general-purpose server computer or a server blade. Each hardware module includes an image of the operating system and one or more application-server processes. The communication module is realized by a specialized implementation of the Java Remote Method Invocation (RMI) API that includes the capabilities of the invention. The application-server process 2202 is realized by an operating-system (O/S) level process that includes the Java Virtual Machine (JVM) 2203, application-server's classes 2204, and one or more execution modules 2205. Application server classes 2204 are Java classes that include the logic necessary to support a method according to the present invention. Execution module 2205 includes one or more Enterprise JavaBeans (EJB) 2206 and runtime artifacts 2207. The Java platform's class-loader mechanism is used to insulate the execution modules from each other. Runtime artifacts 2207 are tools-generated Java classes that are use to support the present invention. The artifact classes are defined as subclasses of the EJB classes and hold the values of the CMP (container-managed persistence) and CMR (container-managed relationship) fields. FIG. 24 illustrates an exemplary artifact class. Enterprise JavaBeans 2206 in an embodiment, an application is a J2EE application whose transactional programs are realized as the EJB business, create, remove, and finder methods (referred to as “Methods” in FIG. 22). The transactional state includes of the values of the EJB CMP and CMR fields.

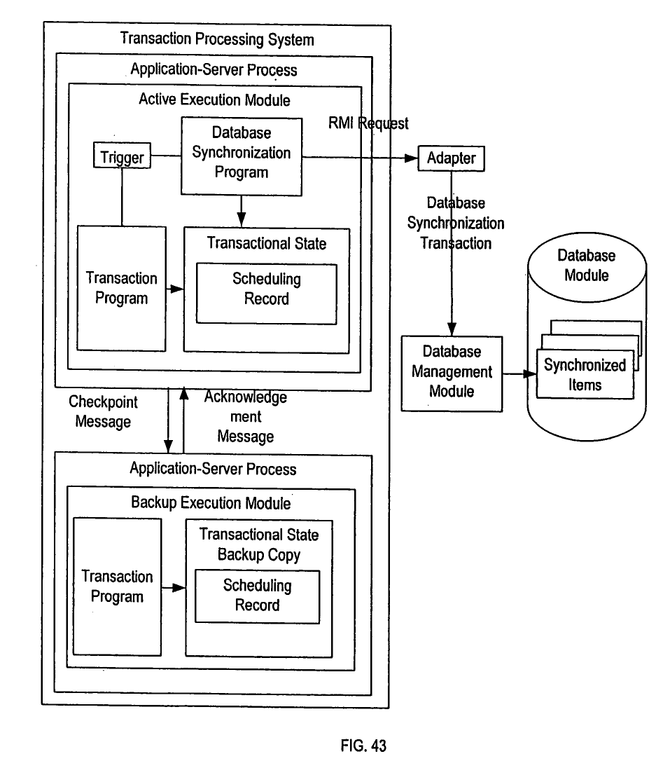

There are also some other aspects of the invention. In some embodiments, the database synchronization program can be implemented as EJB business methods. In some embodiments, the scheduling record of a database synchronization program can be implemented as an EJB object. The existence of the EJB object indicates that a database synchronization program needs to be executed. In some embodiments, the transaction programs are implemented as Java Data Objects (JDO). JDO's are described by the Java Data Objects (JDO) Specification. Sun Microsystems Inc. located at http://java.sun.com/products/jdo. The “Enhancer” technique described in the reference could be used for generating the runtime artifacts. In some embodiments, the external database management module may be a relational database management system. In other embodiments, the backup execution module does not include the transaction programs. In such embodiments, after the failure of an active execution module, a new active execution module is created and its transactional state is created from the transactional state stored in the backup execution module. In even other embodiments, the database synchronization program may not communicate with the database management module directly. For example, the illustrative embodiment depicted in FIG. 43 utilizes an adapter. The database synchronization program communicates with the adapter using the Java Remote Method (RMI) protocol. This type of embodiment would be used, for example, to offload processing from the transaction processing system to other computers.

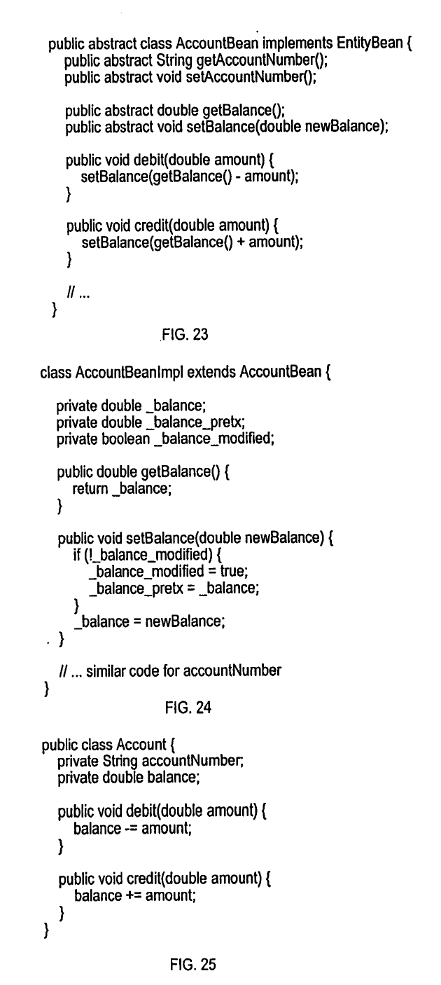

FIG. 23 illustrates an abbreviated Enterprise JavaBean (EJB) component that is an illustrative example of an application suitable for an embodiment of the invention. In FIG. 23, the AccountBean Enterprise JavaBean class includes two transaction programs, debit and credit, which are realized as EJB business methods. The transactional state includes accountNumber and balance EJB CMP fields, which are represented in the EJB by the getAccountNumber, setAccountNumber, getBalance, and setBalance CMP accessor methods. On the other hand, with Net, transactional state items may include values of C# fields and transaction programs may include C# methods.

FIG. 24 illustrates an abbreviated exemplary runtime artifact that could be used in conjunction with the transaction program in FIG. 23. The AccountBeanImpl artifact is intended to be illustrative rather than prescriptive. AccountBeanImpl defines the field_balance, which provides storage for the value of the CMP field balance. AccountBeanImpl also defines the field_balance_pretx, which is used for storing the pre-transaction value of the balance field, and the indicator field_balance_modified, which is used to indicate whether the balance CMP field has been modified by the current transaction and therefore its new value should be included in the checkpoint message. The exemplary implementation of the setBalance accessor method illustrates one possible method for how a runtime artifact can keep track of pre-transaction values of transactional state items. This method is intended to be illustrative rather than prescriptive.

Another Exemplary Embodiment

FIG. 25 illustrates another exemplary embodiment of the invention. In this embodiment, the invention is realized similarly to the previous embodiment, with the exception that the applications are realized as Java classes (or classes of any object-oriented language) rather than EJBs. In this embodiment, applications are realized as classes of an object-oriented programming language, transaction programs are realized as the methods of the classes, and transactional state is realized as the values of all or some fields of the programming-language objects instantiated from the classes.

In the example in FIG. 25, the Java fields accountNumber and balance is an item of a transactional state. The Java methods debit and credit are the transactional programs that manipulate the transactional state. The application-server process would use suitable runtime artifacts to achieve the ACID properties of transactions. For example, it could use the “Enhancer” technique described in the Java Data Objects (JDO) Specification for generating the runtime artifacts.

In another embodiment of the invention, the Account class is realized as a Java Data Object (JDO). This would be accomplished by modifying the Account class definition (the first line in FIG. 25) to “public class Account implements javax.jdo.PersistenceCapable {”. The “Enhancer” technique described in the reference would be suitable for this embodiment of a method of the invention. Other embodiments of the present invention may exist, in addition to those described above.

Example Embodiment of a Method for Synchronizing Data in an External Database with Transactional State

The Java classes depicted in FIG. 23 and in FIGS. 26 through 32 collectively illustrate an embodiment of a method for synchronizing data in an external database with the transactional state. This embodiment is illustrative rather than prescriptive and other possible embodiments are possible.

This particular embodiment illustrates how a trigger, a creation of the scheduling record, and a database synchronization program could be added to a transaction-processing application without the need to change its code, which is an advantage of a method of the invention.

FIG. 26 illustrates the Account EJB local interface that is associated with the AccountBean EJB in FIG. 23. The Account interface defines the accessor methods corresponding to the accountNumber and balance CMP fields and the debit and credit EJB business methods. The methods in the Account interface correspond to the same-named methods in the AccountBean class.

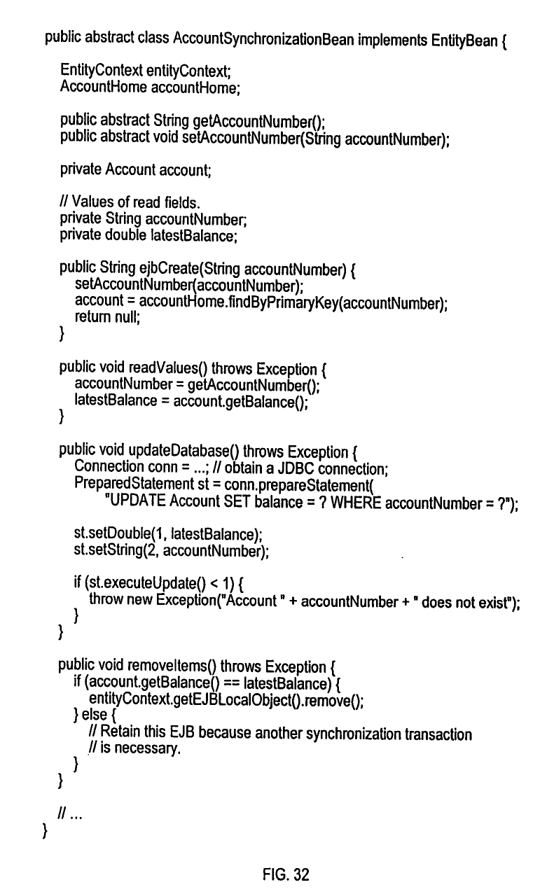

FIG. 27 illustrates an exemplary embodiment of a trigger that associates the transaction program embodied by the debit method with the database synchronization program embodied by the AccountSynchronizationBean EJB in FIG. 32. The debit method in the AccountBean Trigger class interposes on the execution of the debit method in the AccountBean class. After the debit method in the AccountBean class has completed (its execution is illustrated by the super.debit(amount) statement), the trigger creates an AccountSynchronizationBean object.

The AccountSynchronizationBean object is considered to be an embodiment of the scheduling record illustrated in FIG. 14. The implementation of the trigger as illustrated in FIG. 27 ensures that the scheduling record is created if and only if the debit transaction program commits. The AccountSynchronizationBean object is created as an item of the transactional state and therefore its creation is automatically included in the checkpoint message sent to the backup execution module.

FIG. 28 is a modification of the exemplary runtime artifact from FIG. 24 to account for the existence of the trigger mechanism.

The DatabaseSynchronization interface illustrated in FIG. 29 is a Java interface used by a method for managing the execution of database synchronization programs. It defines three methods that correspond to the three steps in the flow chart in FIG. 17. While this exemplary embodiment of the invention uses a Java interface that explicitly breaks the database synchronization program into three discrete Java methods, other embodiments might perform the three steps in a single Java method without using an explicit interface that defines the steps.

FIG. 30 is the EJB local interface associated with the AccountSynchronizationBean EJB illustrated in FIG. 32. It extends, in the sense of the Java programming language, the DatabaseSynchronization interface. FIG. 31 is the EJB local home interface associated with the AccountSynchronizationBean EJB illustrated in FIG. 32.

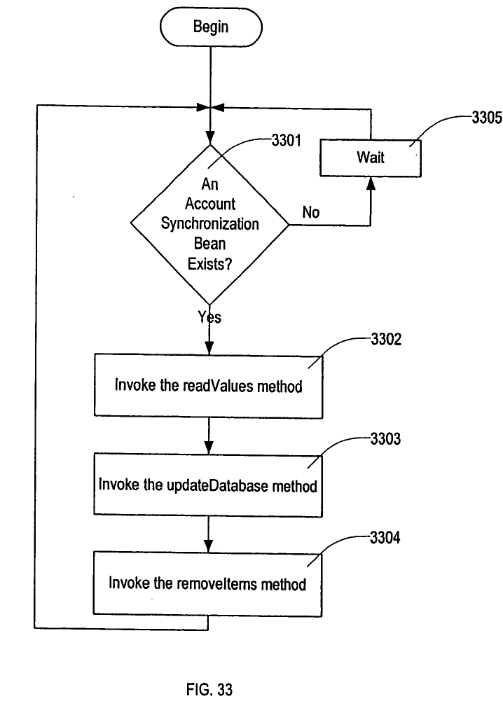

The AccountSynchronizationBean EJB illustrated in FIG. 32 is an exemplary embodiment of a database synchronization program. Its purpose is to read the value of the balance EJB CMP field from the associated AccountBean object and update the value of the corresponding balance field in the Account database table. The ejbCreate method is executed when an AccountSynchronizationBean object is being created by the trigger. The readValues, updateDatabase, and removeItems methods are executed in accordance with the flow chart in FIG. 33.

FIG. 33 illustrates a flow chart with an exemplary algorithm for managing execution of database synchronization programs. The algorithm includes a loop that waits for an AccountSynchronizationBean object to be created by a trigger 3305. When an AccountSynchronizationBean object has been created 3301, the algorithm invokes the readValues 3302, updateDatabase 3303, and removeItems 3304 methods sequentially on the object. These steps are repeated for all AccountSynchronizationBean objects. In this embodiment, the readValues, updateDatabase, and removeItems methods are consider collectively to be the database synchronization program of this invention.

Another Example Embodiment of a Method for Synchronizing Data in an External Database with Transactional State

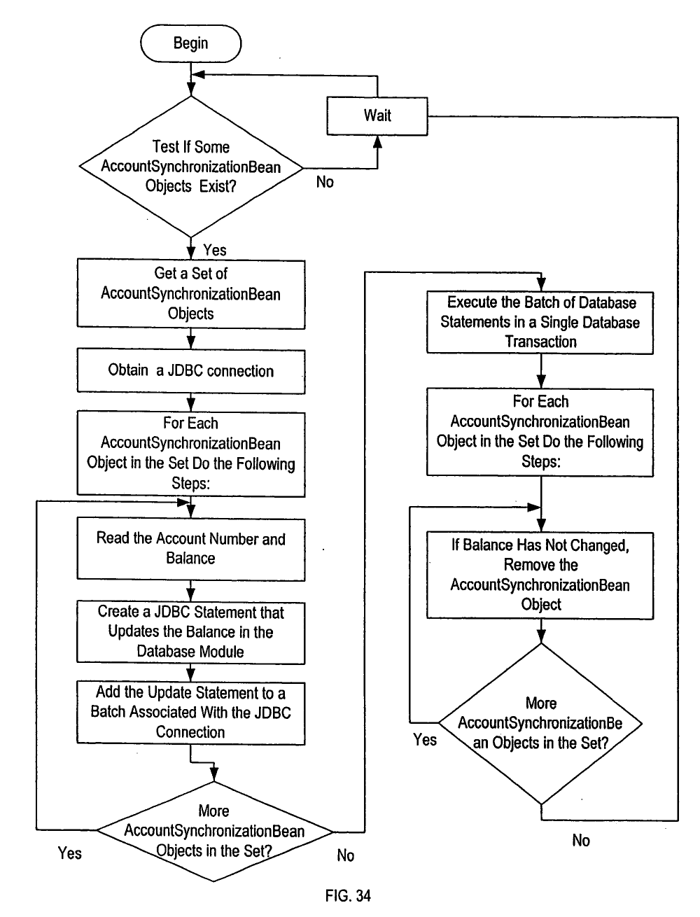

FIG. 34 illustrates a flow chart with an alternative embodiment of the algorithm for managing the execution of database synchronization programs. The steps in FIG. 34 are consistent with the optimization of using a single database transaction to include database update statements associated with multiple scheduling records (the optimization has been described generically in the flow chart in FIG. 18).

The steps of the flow chart, show that the balance of multiple accounts can be updated by a single database transaction, which is one of the main objectives of the optimization.

Embodiments that Use Timers

In a transaction-processing system, sometimes one transaction program wishes to schedule the execution of another transaction program at a specified time in the future. For example, the transaction program that creates an auction may want to schedule the execution of another transaction program that executes three days later to end and finalize the auction.

Time-based scheduling of transaction programs are achieved, in some embodiments, by creating a timer which expires at a specified time and triggers the execution of the second transaction program. One advantage of the invention is that it allows for storing information about timers in the transactional state. The advantages of storing the timers in the transactional state include the advantages enumerated below. First, a timer can be created transactionally (that is, a timer will be created only if the first transaction successfully completes). Second, the information about timers is protected from failures by the checkpointing mechanism between the active and backup execution units.

Some embodiment of the invention use EJB timers. EJB timers are described in the Enterprise JavaBeans™ 2.1 Specification from Sun Microsystems Inc., available at http://java.sun.com/products/ejb.

Embodiments that use Caches and/or Object-Relational Mapping Logic

In some embodiments of the invention, the application-server processes include logic for caching data from a database as programming-language objects. The programming-language objects are often referred to as “state object” or “data objects.” In these embodiments, the transactional state items would most likely be included in the programming-language objects of the cache. Some of these embodiments implement the scheduling record concept described in this invention by using a “dirty” bit in a state object. The dirty bit indicates that the content of the state object needs to written to the database because the content of the state object has been modified by at least one transaction in the transaction-processing system. In some embodiments, the dirty bit is a transactional state item and therefore its value is automatically updated to the backup execution module by the checkpoint messages.

In some embodiments of the invention, the application-server processes include logic for mapping between object and relational formats. In these embodiments, the methods for synchronizing data in a database with the transactional state items and vice versa could be included in the object-relational mapping logic.

Some embodiments of the invention may include both the caching logic and object-relational mapping logic.

Yet other embodiments of the invention might organize transactional state items using technologies based on the Extensible Markup Language (XML). For example, an embodiment of the invention may implement the transactional state items as Service Data Objects (SDO), described in reference “Service Data Objects, IBM Corp. and BEA Systems, Inc. Version 1.0, November 2003.

ftp://www6.software.ibm.com/software/developer/library/j-commonj-sdowmt/Commonj-SDO-Specification-v1.0.doc.”

Embodiments that use Intermediate Servers

In the description of the invention, the clients sent transaction requests directly via the communication module to the transaction processing platform. In some embodiments of the invention, the clients may sent the transaction requests to intermediate servers, such as Web servers, which in turn send the requests to the transaction processing system.

Transaction programs for use in the present invention may be written in any programming language and work with any form of the representation of the transactional state.

Exemplary Application—Online Auction

The present invention will typically be embodied in the implementation of a transaction processing platform. Such a platform is typically a computer-software product that provides APIs (application-programming interfaces) for the development and deployment of transaction-processing applications. A single platform can be used with many different applications. By running on a platform that embodies the present invention, the applications receive the benefits of the invention.

It would be impossible to enumerate all the possible transaction-processing applications that benefit from the invention. Therefore, the exemplary applications described in this patent application should be considered as illustrative rather than prescriptive of the usage of the invention.

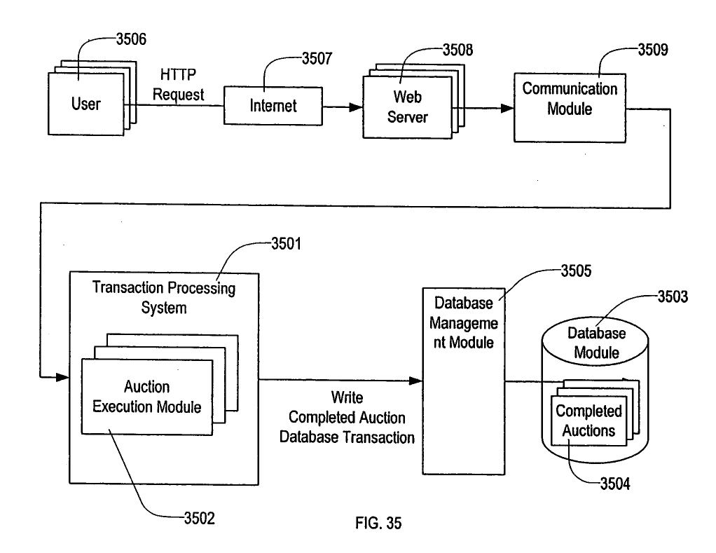

FIG. 35 illustrates how the invention could be used in online auction (such as eBay) applications. The online auction applications benefit from the invention by being able to process many more user transactions per second than a system that uses prior art. It also benefits by being able to processes transactions even if the database management module is unavailable.

In FIG. 35, the Transaction Process System 3501 is a platform that embodies the present invention. The Auction Execution Modules 3502 are execution modules of the Auction application. The execution modules 3502 include the transaction programs and transactional state of the Auction application. Although it is not illustrated in FIG. 35, the transaction-processing system also includes the hardware modules and application-server processes consistent with a method of the present invention.

The database 3503 in FIG. 35 is a database that includes the data items holding information about completed auctions 3504. The database management module 3505 is a database management system that manages the database 3503. The transaction-processing system 3501 uses an application-programming interface provided by the database management module 3505 to write the information about completed auctions to the database 3503.

The Users of the online auction application 3506 use an Internet browsing program to communicate with the application executing in the transaction-processing system 3501 over the Internet 3507. The users' transaction requests are sent in the form of HTTP requests over the Internet 3507 to the Web servers 3508. In response to a user's HTTP request, a Web server 3508 submits a transaction request to the transaction-processing system 3501 using the Communication Module 3509 that is a part of the transaction processing system.

Transaction requests are handled according to a method of the invention: the communication module 3509 delivers a transaction request to the application-server process that has the active execution module with the transaction program and transactional state necessary to process the request; the application-server process starts the execution of the transaction program; during its execution, the transaction program accesses the transactional state in the execution module; upon completion of the transaction program, the application-server process sends a checkpoint message to the associated backup execution module; and the application-server process sends a response to the user, using the steps depicted in the flow chart in FIG. 11, or its variants depicted in FIG. 12 and FIG. 13.

When an online auction completes, the auction application uses a method of the present invention to create the Completed Auctions data items 3504 in the database 3503 and to remove the no-longer-needed transactional state items related to the completed auction from the transaction processing system.

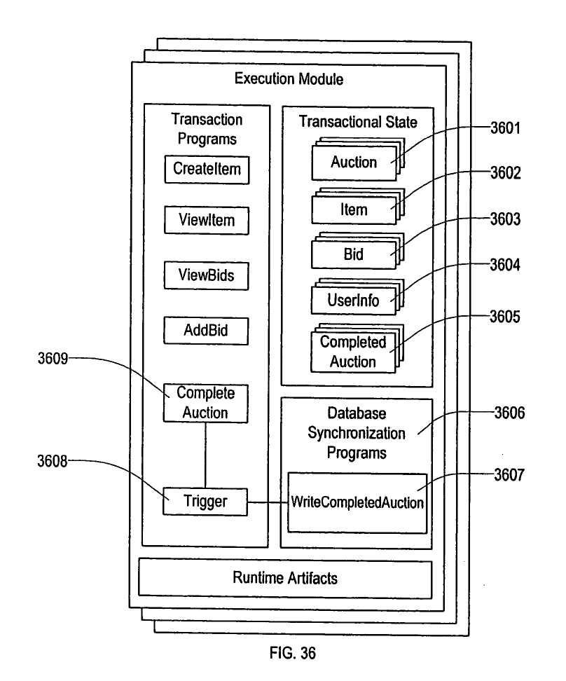

FIG. 36 depicts an execution module of the online auction application. According to a method of the invention, the execution module includes transaction programs, transactional state, runtime artifacts, and database synchronization programs.

To support a large number of concurrent auctioned items, the transactional state is divided into multiple partitions, each including a subset of the auctioned items. According to a method of the invention, each such partition is associated with an active and at least one backup execution module.

The transaction programs include the CreateItem program which is invoked in response to a user submitting a request to create an auction for an item; the ViewItem program which is invoked in response to a user submitting a request to view the status of a given item's auction; the ViewBids program which is invoked in response to a user submitting a request to view the bids associated with a given item; the AddBid program which is invoked in response to a user submitting a request to add his or her bid to a given item; and the CompleteAuction program which is invoked by the transaction-processing system when an timer associated with the auctioned item expires and the auction outcome should be finalized.

The transactional state of the auction application illustrated in FIG. 36 includes the information about the auctions 3601; items being auctioned 3602; collection of bids associated with each item 3603; information about users 3604, such as email address; and the information about completed auctions 3605.

The database synchronization programs 3606 include the WriteCompletedAuctions program 3607, which is executed according to the steps in flow chart in FIG. 17. The WriteCompletedAuctions program reads a CompletedAuction transactional state item, creates CompleteAuction data items in the database, and then removes the CompletedAuction transactional state item.

FIG. 36 illustrates a trigger 3608 that associates the CompleteAuction 3609 transaction program with the WriteCompletedAuctions 3607 database synchronization program according to a method of the present invention. The trigger 3608 causes the transaction-processing system to schedule the execution of the WriteCompletedAuctions 3607 database synchronization program 3606 after each execution of the CompleteAuction 3609 transaction program.

The runtime artifacts are software artifacts generated by the transaction-processing system to support a method of the invention. In one embodiment, the runtime artifacts are in the form of EJB container artifacts. EJB container artifacts are described by the Enterprise JavaBeans™ 2.1 Specification. Sun Microsystems Inc., located at http://java.sun.com/products/ejb.

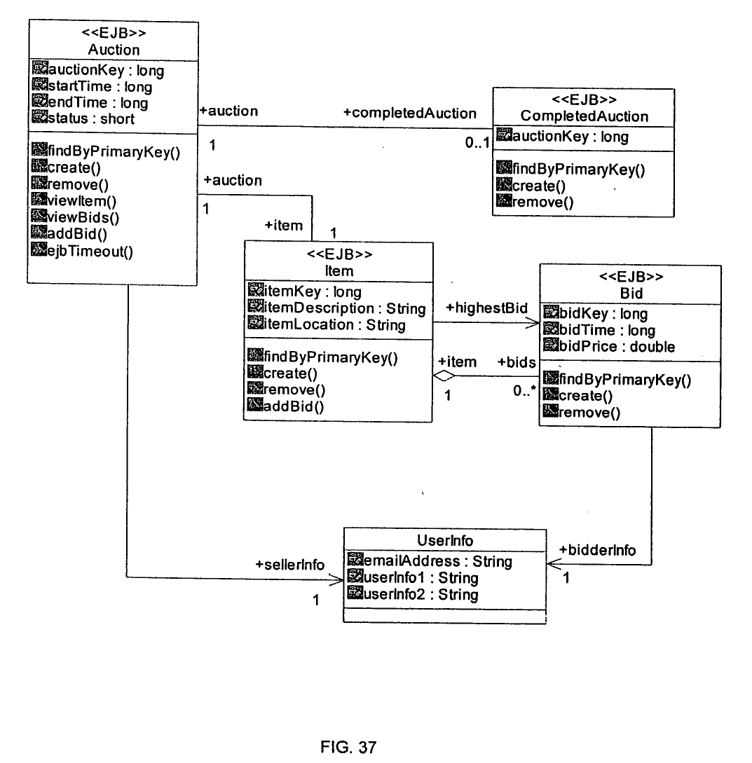

FIG. 37 depicts one possible embodiment of the auction transaction programs and transactional state using the Enterprise JavaBeans (EJB) application programming model. The diagram uses the industry-standard UML (Unified Modeling Language) notation to specify the EJBs, EJB business methods, container-managed fields (EJB CMP fields), and container-managed relationships (EJB CMR fields). The EJB business methods are embodiments of the transaction programs, and the EJB container-managed fields and relationships are embodiments of the transactional state. UML generally is described in: Booch G., Rumbaugh J., and Jacobson J. The Unified Modeling Language User Guide. Addison-Wesley, 1999.

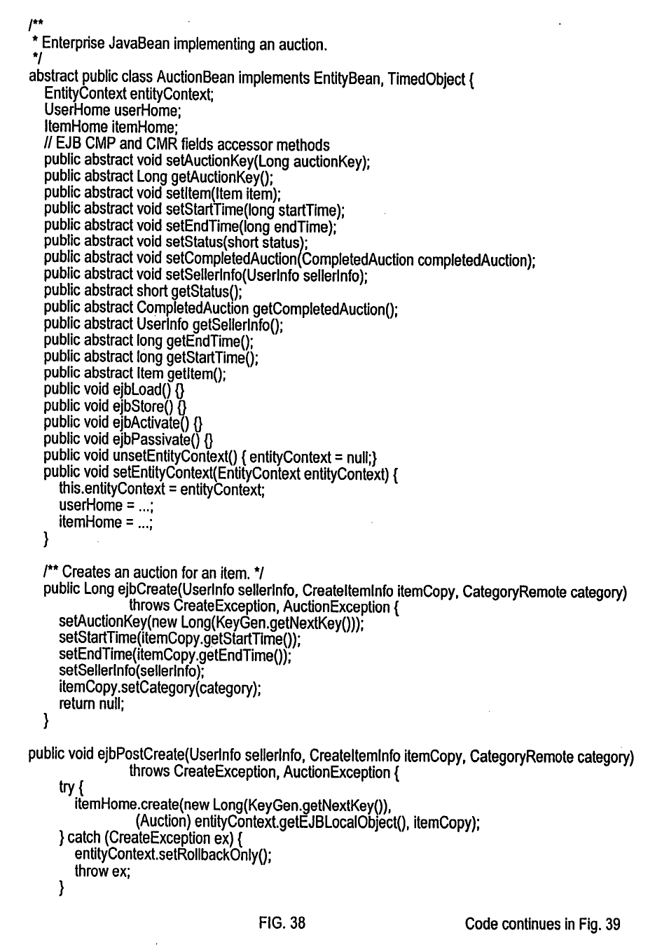

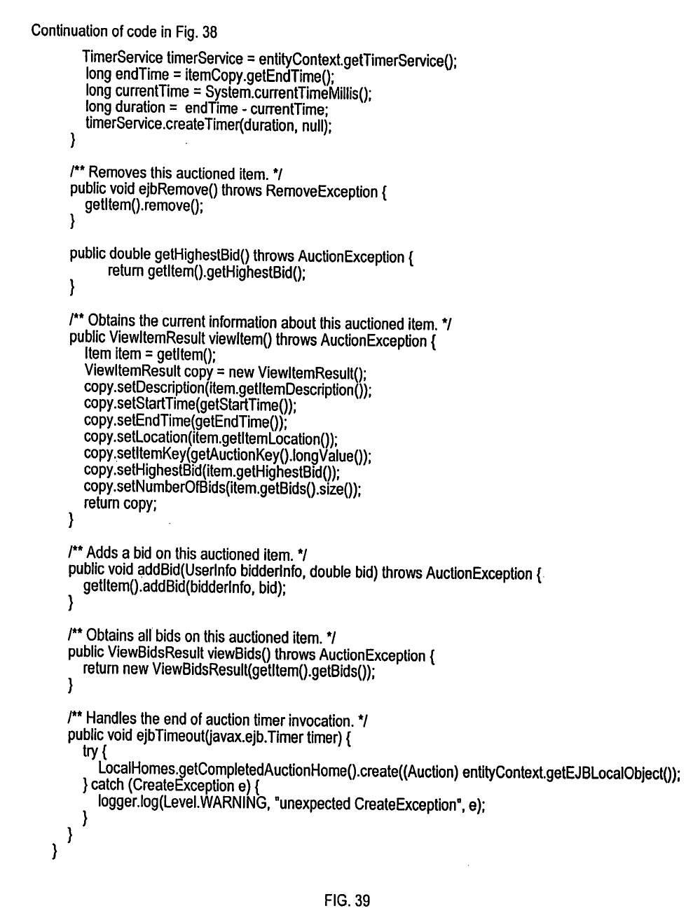

The Java code in FIGS. 38 and 39 illustrate an exemplary implementation of the AuctionBean Enterprise JavaBean (the code of the other Enterprise JavaBeans is not included). Some aspects of EJBs include the following. The methods of the AuctionBean EJB are one possible embodiment of the transaction programs according to the system and method of the invention. The EJB CMP and CMR fields are one possible embodiment of the transactional state items according to the system and method of the invention. The ejbTimeout method is one possible implementation of the CompleteAuction transaction program described earlier. The ejbTimeout method includes a trigger of a database synchronization program consistent with the method and system of the invention. A CompletedAuction EJB object is a scheduling record of a database synchronization program consistent with the method and system of the invention.

The Java code in FIGS. 40 and 41 illustrates one possible embodiment of a database synchronization program according to a method of this invention. The DatabaseUpdateThread is one possible implementation of the method depicted generically in FIG. 18. The results of multiple auctions could be written to an external database in a single database transaction. The auction transactional processing system is capable of processing online transactions even if the external database is offline for a period of time. The result of all completed auctions will be eventually written to the database even if the database management module is offline for a period of time.

Exemplary Application—Service Control Point in Telecommunication Networks

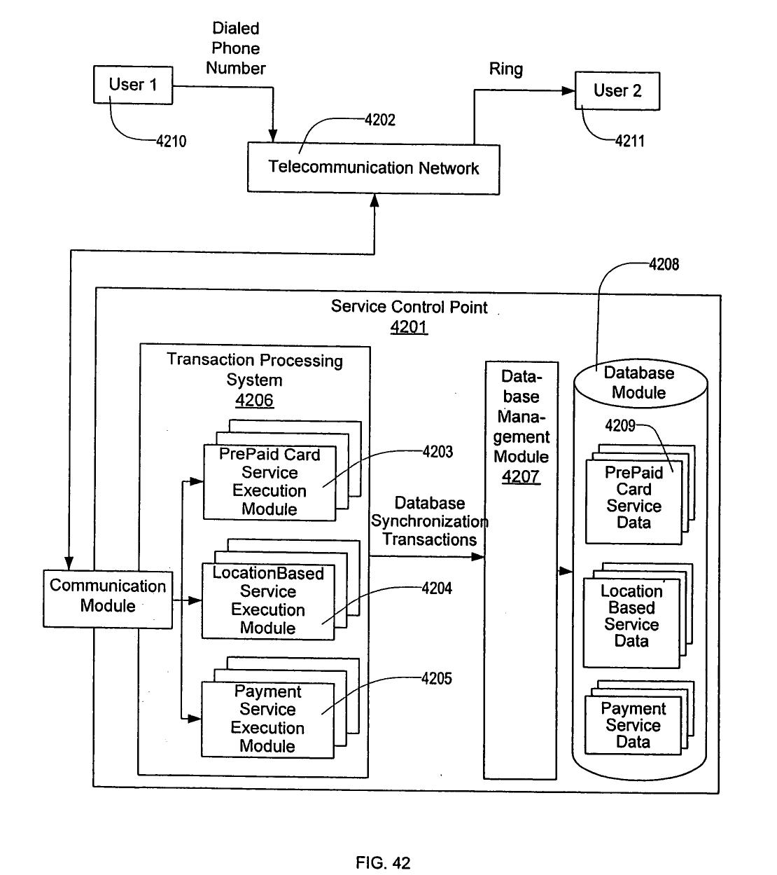

FIG. 42 illustrates another exemplary application of the present invention. The application is a Service Control Point (SCP) 4201 used in a telecommunication network.

An SCP 4201 includes one or several telecommunication services. The telecommunication network 4202 can interact with an SCP both during the establishment of a telephone connection and at anytime during the lifetime of the connection.

The SCP 4201 illustrated in FIG. 42 includes three representative services: PrePaid Card service 4203, which allows a service provider to charge a user for telephone connections by debiting an account established by the user's prepaid telephony card; a location-based service 4204 that provides different information to a mobile-phone user based on his current location; and a Payment service 4205 which links a user's mobile phone with his banking account and thereby allows him to pay for goods or services by executing real-time payment transactions via his mobile phone. The three described services should be considered as illustrative not prescriptive of a Service Control Point 4201.

A Service Control Point 4201 typically must support a large number of users, provide continuous availability, and provide responses to the telecommunication network in short, bounded time. Therefore, it benefits from the present invention. FIG. 42 illustrates one implementation of an SCP to take advantage of the present invention. The SCP 4201 in FIG. 42 includes a transaction-processing system 4206 consistent with the present invention; a database management module 4207; and a database 4208.

The execution modules included in the transaction-processing system 4206 are the execution modules corresponding to the individual services that are configured into the SCP 4201. The illustrative SCP 4201 in FIG. 42 includes multiple execution modules belonging to the PrePaid Card service 4203; multiple execution modules belonging to the location-based service 4204; and multiple execution modules belonging to the Payment service 4205.

Although it is not illustrated in FIG. 42, the transaction-processing system also includes the hardware modules and application-server processes consistent with a method of the present invention.

The database 4208 includes data items that are associated with the services. For example, the data items associated with the PrePaid Card 4209 may include, among other information, the remaining balance of the user's prepaid card account.

Telephony users interact with each other via the telecommunication network 4202. The telecommunication network 4202 is configured to interact, in real time, with the Service Control Point 4201. For example, when User 1 4210 dials the phone number of User 2 4211, the telecommunication network 4202 first sends a request to the SCP 4201. The SCP 4201 determines that User 1 4210 uses a prepaid card and invokes an appropriate transaction program in the PrePaid Card Service execution module 4203. The transaction program checks if the balance in User 1's account is sufficient to establish the telephone connection. If the balance is sufficient, the SCP 4201 sends a confirmation message to the telecommunication network 4202, which in turn completes the establishment of a telephone connection between User 1 4210 and User 2 4211. As a result, User 2's telephone will start ringing.

During the lifetime of the telephone connection, the PrePaid card service will periodically debit the remaining balance in User 1 account by invoking a transaction program. The transaction program updates the balance that is represented as an item of the transactional state in the execution module. Should the balance drop to zero, the transaction program will send a message to the telecommunication network causing it to disconnect the telephone connection.

At the end of the telephone connection, the PrePaid card service uses the present invention to synchronize the prepaid card account balance in the database with the updated balance kept in transactional state in the execution modules. Consistent with the present invention, the transaction-processing system in SCP uses the active and backup execution modules to achieve tolerance to failures and continuous availability.

Exemplary Application—Execution Control System

In some embodiments of the present invention, the transaction programs included in the transaction-processing system control the execution of other applications, including the execution of other transaction-processing applications. The controlled applications may be included in the same or different transaction-processing system from the one including the controlling transaction programs, or not be included in any transaction-processing system. The transaction programs that control the execution of other programs are collectively called execution control system. The following description illustrates how an exemplary execution control system could take advantage of the system and method of the present invention.

The following description is an abbreviated description of the execution control system described in detailed in U.S. Provisional Patent Application No. 60/519,904, titled METHOD AND APPARATUS FOR EXECUTING APPLICATIONS ON A DISTRIBUTED COMPUTER SYSTEM.

Execution Control System

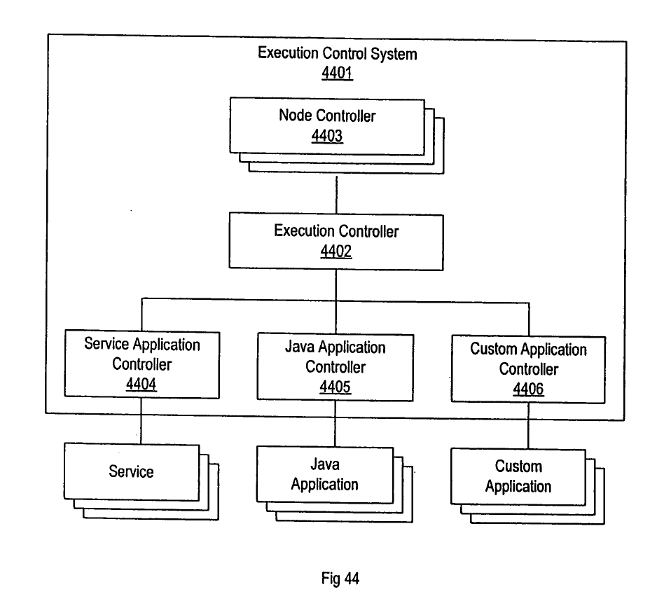

FIG. 44 illustrates the main components of the execution control system (“ECS”) 4401 and their relationship to applications executing under the supervision of the execution control system.

ECS 4401 includes an execution controller 4402, one or more node controllers 4403, and one or more application controllers. Each application controller implements the execution model suitable for a particular type of applications supported on the distributed computer system.

For example, the exemplary ECS system in FIG. 44 includes three application controllers: a service application controller 4404, which is suitable for controlling applications that are services including operating-system level processes; a Java application controller 4405, which is suitable for controlling Java applications including containers and execution modules (a container is a process that includes the runtime libraries necessary for the execution of a given type of execution modules); and custom application controller 4406, which is suitable for controlling applications that have a custom structure and require a custom application execution model. As an example, the “application-server process” described in this disclosure is considered a container

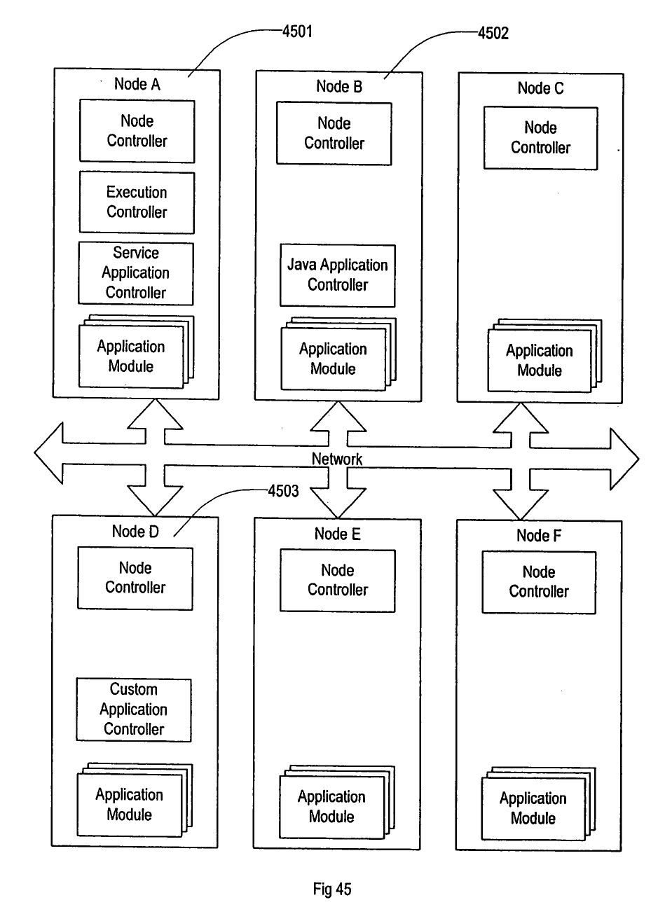

The node controllers 4403, execution controller 4402 and application controllers are distributed over the nodes of a distributed computer system. FIG. 45 illustrates an exemplary distributed computer system including nodes interconnected by a network. The distributed computer system includes an execution control system that controls applications running on the distributed computer. The exemplary distributed computer system includes six nodes but other embodiments of the invention may use fewer or more nodes. A node in the distributed computer system is an embodiment of a hardware module of the present invention. Each node in the distributed computer system includes a node controller.

Node A 4501 includes the execution controller and the service application controller. Node B 4502 includes the Java application controller. Node D 4503 includes the custom application controller. The nodes in the exemplary distributed computer system illustrated in FIG. 45 that include the parts of the execution control system also include application units. Application units are, for example operating-system level processes and other types of executable objects such as execution modules. In other embodiments of the execution control system, the application units could be located on different nodes from the nodes that include the execution controller and the application controllers.

Execution Controller (EC)

The execution control system includes an execution controller 4504. The main purpose of the execution controller 4504 is to provide an easy to use, fault-tolerant abstraction of the distributed computer system to the application controllers. The model of the distributed computer system provided by the execution controller 4504 includes nodes, node groups, and processes. Without the execution controller, each application controller would have to implement the execution controller's functionality, which would make the development of application controllers hard. It would also make achieving a single-system image difficult because each application controller would include its own concept of processes and node groups, thus making the distributed computer system look like having a collection of several independent software platforms rather than a single software platform.

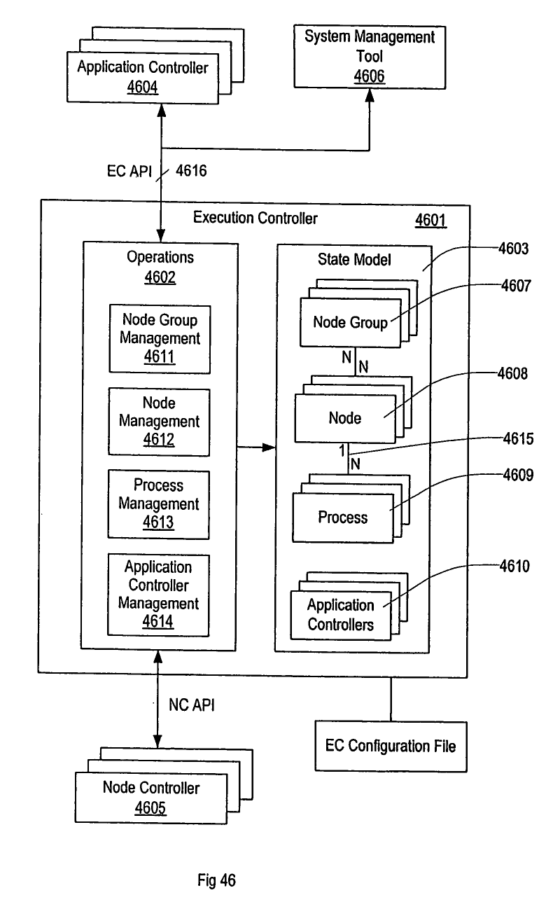

The functionality of the execution controller 4601 is depicted in FIG. 46. The execution controller 4601 includes operations 4602 and a state model 4603. The execution controller interacts with application controllers 4604, node controllers 4605, and a system management tool 4606.

The operations included in the execution controller 4601 implement the management of node groups 4607, nodes 4608, processes 4609, and application controllers 4610. The operations describes below are typical to most embodiments of the execution controller 4601, but some embodiments might omit some operations or include additional operations.

There are also several operations 4602 that may be implemented. The “node group management” operations 4611 include the operations to create and remove a node group; operations to add and remove a node from a node group; and operations to obtain status information about the node groups. The “node management operations” 4612 include operations to add and remove a node from the distributed computer system; an operation to respond to a node failure notification; an operation to respond to a notification indicating that a node has been repaired; and operations to obtain status information about the nodes. The “process management operations” 4613 include the operation to start an operating-system level process with specified command line arguments on a specified node; an operation to stop a previously started process; an operation to respond to a process failure notification; and operations to provide status information about processes. The “application controller management” operations 4614 include operations to start an application controller and its optional backup copy on specified nodes; an operation to respond to an application controller or its backup copy failure notification; operations to add new application controllers to the system; and operations to obtain information about application controllers.

The state model includes objects that present nodes 4608, node groups 4607, processes 4609, and application controllers 4610 in the distributed computer system. The state model also includes relationships among the objects. The execution controller 4601 maintains its state model objects up to date so that they reflect the current state of the distributed computer system.

The illustration of the execution controller state model in FIG. 46 uses the notation for relationships used in class diagrams of the Unified Modeling Language (UML). A relationship between two objects is represented by a line between the two objects. An optional number at the end of the line indicates whether an object can be associated with at most one, or with multiple instances of the other object. For example, the numbers at the end of the line between the Node 4608 and Process 4609 objects in 4615 FIG. 46 indicate that a Node 4608 object can be associated with multiple Process 4609 objects and that a Process 4609 object can be associated only with a single Node 4608 object.

This UML-like notation is used also in the illustrations of the application controller's state models.

The execution controller 4601 includes an event notification mechanism that sends event notifications to registered subscribers when an object in the state model has been created, been removed, or its status changed. For example, an appropriate event notification is sent when a process has been started or stopped, or when the execution controller has received a process failure notification from a node controller.

The execution controller 4601 exposes its operations to the application controllers 4604, system management tools 4606, and other users via the Execution Controller Application Programming Interface (“EC API”) 4616. The EC API 4616 allows application controllers to invoke the execution controller's 4601 operations 4602 and subscribe to the event notifications generated in response to the state model changes. The EC API 4616 is the primary means for the application controllers 4604 to manage the execution of processes distributed over the nodes of the distributed computer system.

The EC API 4616 could be used by other components in addition to the application controllers 4604. For example, a system management tool uses the EC API 4616 to define node groups 4607 and obtain status information about the nodes 4608, node groups 4607, and processes 4609. The EC API 4616 provides a single-system image of the distributed computer system including multiple nodes to its users.

In some embodiments, the EC API 4616 is bridged into a standard API used for system management, such as Java Management Extensions (“JMX”). This allows standard system management tools that conform to the JMX API to invoke the execution controller operations and to subscribe to its events.

The execution controller 4601 communicates with node controllers 4605 located on the nodes 4608 of the distributed computer system by using the NC API provided by the node controllers 4605. The NC API allows the execution controller 4601 to start and stop operating-system level processes on the nodes, and to receive a failure notification when a process fails.

The execution controller 4601 is associated with its configuration file. The configuration file includes information that the execution controller 4601 uses at its startup. The information in the configuration file includes the specification of the application controllers 4604 that the execution controller 4601 should create at startup; optional information specifying on which nodes 4608 each application controller should be started; optional information specifying on which nodes a backup copy of each application controller 4604 should be created; and optional specification of the node groups 4607 that should be created at execution controller 4601 startup. In some embodiments, EC 4601 is realized as a transaction-processing application.

Service Application Controller (SAC)

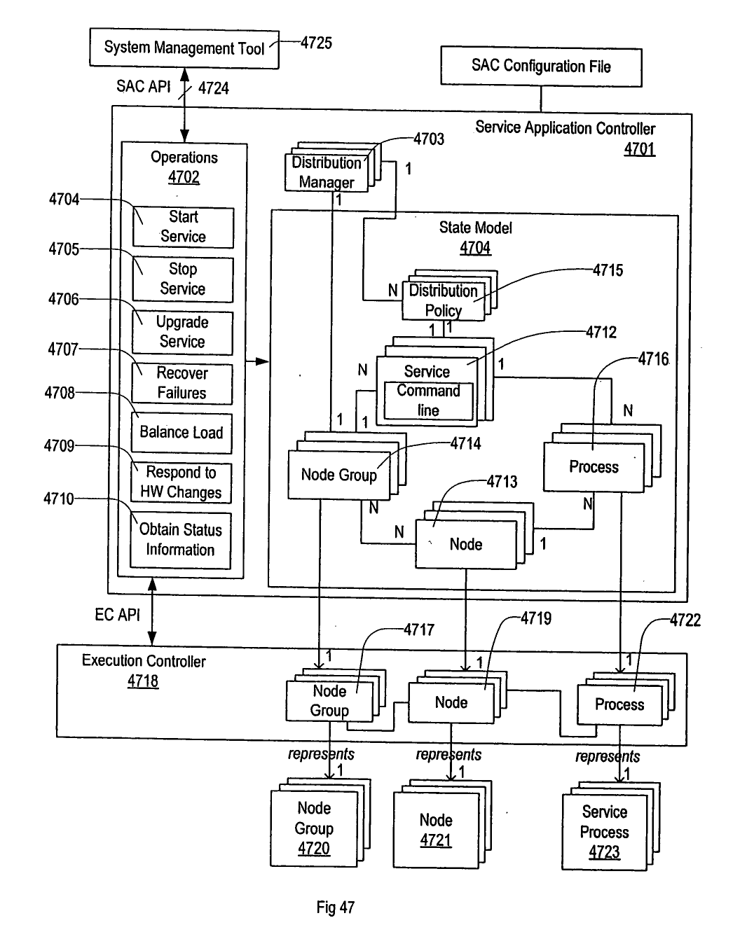

FIG. 47 illustrates the main SAC 4701 components. SAC 4701 includes operations 4702, one or more Distribution Manager 4703 objects, and state model 4704. The “start service” operation 4705 starts a service by starting its constituent service processes according to the Distribution Policy object associated with the service. The “stop service” operation 4706 stops a service by stopping all its service processes. The “upgrade service” 4707 operation replaces a previous version of the service processes with a new version. The “recover failures” operation 4708 recovers a service from the failure of its constituent service processes. The recovery action depends on the Distribution Policy object associated with the service and the type of the failure (i.e. whether the failure was a node failure or process failure). The “balance load” operation 4709 can stop a process running one node and restart it on a different, less loaded node. The balance load operation is invoked internally by the service application controller when it detects that a node is overloaded while other nodes have spare capacity or explicitly by an operator. Any load-balancing decision is subject to the Distribution Policy object and node group associated with a service. This means, for example, that SAC will never start a process on a node that is not a member of the node group associated with a service. The “respond to hardware (HW) changes” operations 4710 adjust the distribution of processes over the nodes after a node has been added to the distributed computer system, or a node has been removed from it. Any adjustments made by SAC are subject to the Distribution Policy object and node group associated with the services. The “obtain status information” operations 4711 allow other applications and the system management tool to obtain service status information.

SAC includes one or more Distribution Manager objects 4703. SAC includes state model 4704 including objects. The objects represent services 4712, nodes 4713, node groups 4714, and distribution policies 4715. The notation used in the state model diagram is explained in the description of the execution controller state model in FIG. 46.

A Service object 4712 represents a service. A Service object 4712 includes the command line that is used to start associated service processes. Each Service object 4712 is associated with a Distribution Policy object 4715, a Node Group object 4714, and one or more Service Process objects 4712. The SAC state model can include multiple Service objects 4712, each representing a service running on the distributed computer system.

The Distribution Policy objects 4715 provide parameters to the algorithm of the Distribution Manager objects 4703. They affect how many processes a Distribution Manager object 4703 will create on behalf of a service and how it will distribute the processes 4716 over the nodes 4713 of the associated node group 4714. Exemplary Distribution Policy objects 4715 will be discussed later.

The Node Group objects 4714 correspond to the Node Group objects 4717 in the execution controller 4718 and represent the node groups 4720 defined in the distributed computer system. SAC 4703 uses the EC API 4719 to maintain its Node Group objects 4714 synchronized with the Node Group objects 4717 in the execution controller.

The Node objects 4713 correspond to the Node objects 4719 in the execution controller 4718 and represent nodes 4721 in the distributed computer system. SAC 4701 uses the EC API 4719 to maintain its Node objects 4713 synchronized with the Node objects 4719 in the execution controller 4718.

The Process objects 4716 represent service processes 4723 running on some node 4721 of the distributed computer system. A Process object 4716 is associated with a Service object 4712 and corresponds to a Process object 4722 in the execution controller's 4718 state model. SAC 4701 uses the EC API 4719 to maintain the state of its Process objects 4716 synchronized with the state of the corresponding Process objects 4722 in the execution controller 4718.

SAC 4701 includes an event notification mechanism that sends event notifications to interested subscribers when an object in the state model has been created, removed, or its state has been changed. For example, an appropriate event notification will be sent when a service 4712 has been started or stopped.

The service application controller 4701 exposes its operations via the Service Application Controller Application Programming Interfaces (“SAC API”) 4724. The SAC API 4274 allows a system management tools 4725 and other system components to invoke the SAC operations 4702 and to subscribe to its events. The SAC API 4724 provides a single-system image of the distributed computer system including multiple nodes 4721 to its users. In some embodiments, the SAC API 4724 is bridged into a standard API used for system management, such as Java Management Extensions (“JMX”). This allows standard system management tools that conform to the JMX API to invoke the SAC operations and to subscribe to its events.

SAC 4701 interacts with the execution controller operations 4702 by using the EC API 4719. For example, SAC 4701 uses the EC API 4719 to start and stop processes on the nodes of the distributed computer system. When SAC 4701 is started, it reads its configuration file. In some embodiments, SAC 4701 is realized as a transaction-processing application.

Java Application Controller (JAC)

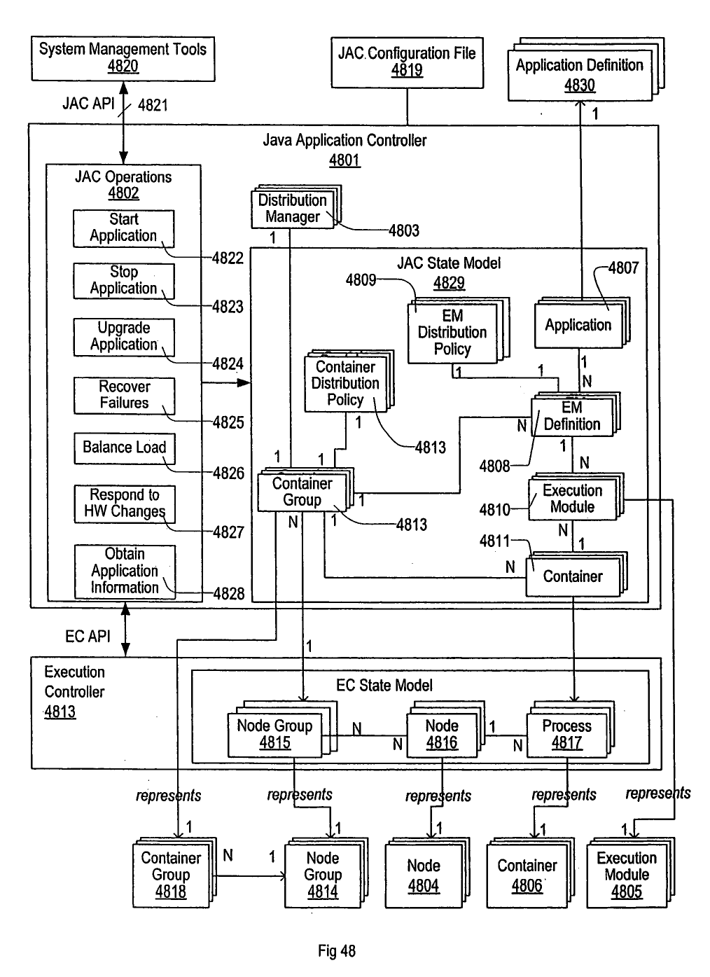

FIG. 48 illustrates JAC's 4801 internal structure. It also illustrates the relationships between JAC 4801 and other components of the execution control system. JAC 4801 includes operations 4802, one or more Distribution Manager objects 4803, and state model 4829.

Although the operations and state model are illustrated as logically separate, in some embodiment of JAC 4801, the operations and state model are closely integrated in programming language objects, such as in Java objects or Enterprise JavaBeans.

The “start application” operation 4822 implements the algorithm for starting an application. JAC starts an application by starting containers and creating the execution modules associated with the application's execution module definitions in the containers. The containers and execution modules are distributed in accordance to the distribution policies associated with the container groups and execution module definition. A method for starting an application is described later in this disclosure.

The “stop application” operation 4823 implements the algorithm for stopping an application. JAC stops an application by removing the execution modules associated with the application and optionally stopping the containers that are no longer needed.

The “upgrade application” operation 4824 implements the algorithm for upgrading an application to a new version of software. JAC orchestrates the upgrade by starting containers with the new version of the application server classes, creating execution modules using the new version of the application definition 4830, removing the old execution modules, and stopping old containers.

The “recover failures” operations 4825 implement the handling of various failures in the distributed computer system, including the failures of execution modules, containers, and nodes. In general, a failure is handled by restarting the failed execution modules and containers on some of the remaining nodes of the distributed computer system. In one embodiment, JAC associates each execution module with a standby execution module. The standby execution module includes a copy of the execution module's state. If a failure results in the loss of the execution module's state, the backup execution module is used for failure recovery.

The “balance load operations” 4826 implement the algorithms for leveling the application workload across the nodes of the distributed computer system. If one node is becoming overloaded while other nodes have spare capacity, JAC may transfer some execution modules from the overloaded node to other, less loaded nodes.

The “respond to hardware changes” operations 4827 implement the algorithms to redistribute the applications across the nodes of the distributed computer system in response to nodes being added or removed from the system. JAC uses its capabilities for transferring execution modules and starting and stopping containers to respond to hardware changes.

The “obtain application information” operations 4828 return status information about the running applications.

JAC 4801 includes one or more Distribution Manager objects 4803. A Distribution Manager object 4803 implements the algorithm for how containers are distributed over nodes 4804 and how execution modules 4805 are distributed over containers 4806. The algorithm of a Distribution Manager 4803 object is parameterized by distribution policy objects. The Distribution Manager 4803 and distribution policy objects are explained below.

JAC 4801 maintains knowledge of the state of the distributed computer system and applications 4807 running on it in its state model. FIG. 48 illustrates representational JAC state model objects and relationships among the objects. The state model objects in FIG. 48 should be considered as illustrative rather than prescriptive. The notation used in the relationships between state model objects is described in the description of FIG. 46.

Each running application is represented in the state model by an Application object 4807. Each Application object 4807 is associated with one or more Execution Module (EM) EM Definition objects 4808. An Application object 4807 corresponds to an application definition 4830 from which the application has been started. An EM Definition object 4808 includes the information from the EM definition in the application definition 4830. Each EM Definition object 4808 is associated with an EM Distribution Policy object 4809 and one or more execution modules 4805.

Every execution module 4805 in the distributed computer system is represented in the JAC state model by an Execution module object 4810. Each Execution module object 4810 is associated with an EM Definition object 4808, and with a Container object 4811.

A Container object 4811 represents a Java container process (“container”) running on some node 4804 of the distributed computer system and is associated with a Process object 4812 in the execution controller state model 4813.

Every container group is represented in the JAC state model by a Container Group object 4811. Each Container Group object 4811 is associated with a Distribution Manager object 4803 which includes the algorithm for distributing containers and execution modules for this container group; a Container Distribution Policy object 4813 which specifies how the Distribution Manager object shall distribute containers 4806 over the nodes 4804 of the node group 4814; one or more EM Definition objects 4808 representing EM definitions assigned to the container group; and one ore more Container objects 4811 representing the containers that belong to this container group.

As depicted in FIG. 48, a Container Group object 4811 is also associated with a Node Group object 4815 in the EC 4813 state model. A container group 4811 logically includes all the nodes in the associated node group. As explained previously, the Node objects 4816 and Process objects 4812 within the EC 4813 state model represent the nodes 4804 and processes in the distributed computer system.

FIG. 48 also depicts the actual parts of the distributed computer system that are represented by the objects in the state model: container groups 4818, node groups 4814, nodes 4804, containers 4806, and execution modules 4805.

JAC 4801 is associated with a configuration file. At startup, JAC 4801 reads the JAC configuration file 4819 to discover, among other things, the default container group and default distribution policy object that the JAC 4820 uses for the application whose EM definitions do not specify a container group or distribution policy objects.

JAC 4801 includes an event mechanism. When a significant event has occurred, such as when an execution module or container has been created, JAC 4801 generates an event notification. The notification is sent to all subscribers who registered to receive the event. JAC exposes 4801 its operations 4802 to the system management tool 4820 and other components via the Java Application Controller Application Programming Interface (“JAC API”) 4821. The JAC API 4821 allows the system management tool 4820 and other components to manage the lifecycle of application by invoking the JAC operations 4802 and subscribing to the JAC event notifications. The JAC API 4821 provides a single-system image of the applications running on a distributed computer system including multiple nodes to its users. In some embodiments, the JAC API 4821 is bridged into a standard API used for system management, such as Java Management Extensions (“JMX”). This allows standard system management tools that conform to the JMX API to invoke the JAC operations and to subscribe to its events. In some embodiments, JAC 4801 is realized as a transaction-processing application according to the method and system of this invention.

Relevance to the Present Invention

The EC, SAC, and JAC components of the ECS can be implemented using the system and method of this invention. In one possible embodiment, the EC, SAC, and JAC operations are realized as transaction programs, and the EC, SAC, and JAC state model is realized as transactional state items. In some embodiments, the EC, SAC, and JAC operations are realized as EJB methods, and their state models are included in EJB CMP and CMR fields. In some embodiments, the EC, SAC, and JAC operations are realized as methods of Java Data Objects (JDO) and their state models are included in the fields of the JDO objects.

The advantages of realizing the ECS component (including the EC, SAC, and JAC components) as transaction-processing applications according to the system and method of the invention include the following. First, the ECS components are highly-available. They will continue functioning even in the presence of hardware and software failures. Second, The ECS components can handle a large number of requests per second because of the high efficiency of the present invention. Third, it is easier to develop, test, and maintain the ECS components. This is because the invention is compatible with the tools for rapid application development and various industry standards (including EJB, UML, JDO, and Java). In contrast, the ECS components developed according to the methods of prior art use proprietary, hard-to-use programming models.

What is claimed is:

1. A method for processing transaction requests from a plurality of clients in a transaction processing system including at least one active execution module, at least one backup execution module and a communication module, the method including the steps of:
receiving a transaction request from a client at the communication module;
routing the transaction request from the communication module to an active execution module;
processing the routed transaction request in the active execution module, wherein the processing includes at least one of accessing, reading, creating, updating and removing transactional state items; and
sending a checkpoint message from the active execution module to a corresponding backup execution module if a transactional state item was created, updated or removed.

2. The method for processing transaction requests of claim 1, wherein a transactional state item may be accessed by a plurality of clients.

3. The method for processing transaction requests of claim 1, including the step of:
sending an acknowledgement message from the backup execution module to a corresponding active execution module.

4. The method for processing transaction requests of claim 1, wherein at least one transactional state item includes the value of a container-managed persistence field of an Enterprise JavaBean entity object.

5. The method for processing transaction requests of claim 1, wherein at least one transactional state item is an object of an object-oriented programming language.

6. The method for processing transaction requests of claim 3, wherein the backup execution module sends the acknowledgement message to the corresponding active execution module after the backup execution module updates the transactional state items corresponding to the checkpoint message.

7. The method for processing transaction requests of claim 6, including the step of:
sending a response message from the active execution module to the client.

8. The method for processing transaction requests of claim 1, including the steps of:
updating transactional state items corresponding to the checkpoint message in the backup execution module; and
sending a response message from the backup execution module to the client.

9. The method for processing transaction requests of claim 1, including the step of:
sending a response message from the active execution module to the client if the routed transaction request does not alter any transactional state item.

10. The method for processing transaction requests of claim 3, wherein the processing includes:
attempting to obtain a lock for at least one transactional state item corresponding to the routed transaction request; and
if a lock is obtained then performing at least one of accessing, reading, creating, updating and removing transactional state items corresponding to the obtained lock;
wherein the method further includes the step of releasing an obtained lock upon receipt of the acknowledgement message at the active execution module.

11. The method for processing transaction requests of claim 10, wherein, if at least one shared lock and at least one exclusive lock are obtained then additionally performing the steps of:
releasing at least one obtained shared locks upon completing the processing of the routed transaction request in the active execution module; and
releasing at least one obtained exclusive locks upon receipt of the acknowledgement message at the active execution module.

12. The method for processing transaction requests of claim 10, wherein at least one transactional state item includes the value of a container-managed persistence field of an Enterprise JavaBean entity object.

13. The method for processing transaction requests of claim 10, wherein at least one transactional state item is an object of an object-oriented programming language.

14. The method for processing transaction requests of claim 6, including the step of:
sending at least one of a data update, data remove and data create message from the active execution module.

15. The method for processing transaction requests of claim 14, including the step of:
at least one of updating, removing and creating a corresponding record in the database module upon receipt of the database update message.

16. The method for processing transaction requests of claim 15, including the steps of:
sending a completion message from the database management module to the active execution module;
at least one of creating, updating and removing transactional state items in the active execution module corresponding to the received completion message; and
sending a checkpoint message from the active execution module to its corresponding backup execution module.

17. The method for processing transaction requests of claim 16, wherein at least one transactional state item includes the value of a container-managed persistence field of an Enterprise JavaBean entity object.

18. The method for processing transaction requests of claim 16, wherein at least one transactional state item is an object of an object-oriented programming language.

19. A method for processing transaction requests in a transaction processing system including the steps of:
starting a processing of a transaction in an execution module;
obtaining a lock to prevent other transactions from accessing at least one transactional state item;
accessing at least one of the at least one transactional state item by the processing of the transaction;
determining if at least one transactional state item accessed by the transaction is not located in the execution module and upon such a determination:
rolling back the processing of the transaction;
retrieving the at least one transactional state item not located in the execution module from the database module and storing it in the execution module; and
restarting the processing of the transaction in the execution module.

20. The method for processing transaction requests in a transaction processing system of claim 19, further including throwing a programming language exception when rolling back.

21. The method for processing transaction requests in a transaction processing system of claim 20, wherein the programming language exception includes the identity of the transactional state item not located in the execution module.

22. The method for processing transaction requests in a transaction processing system of claim 19, wherein the transactional state item not located in the execution module is an Enterprise Java Bean object.

23. The method for processing transaction requests in a transaction processing system of claim 22, wherein throwing a programming language exception includes sending the primary key of the Enterprise Java Bean object.

24. The method for processing transaction requests in a transaction processing system of claim 19, wherein the transactional state item not located in the execution module is an object of an object oriented programming language.

25. A method for processing transaction requests in a transaction processing system including the steps of:
creating, modifying and/or removing a record in a database module;
triggering the sending of a transaction request to a communication module to at create, modify and/or remove a transactional state item in an execution module;
routing the transaction request from the communication module to an active execution module;
processing the routed transaction request including at least one of accessing, reading, creating, updating and removing transactional state items;
determining if a transactional state item was at least one of created, updated and removed, and upon such a determination sending a checkpoint message from the active execution module to the corresponding backup execution module.

26. A method for initializing a transaction processing system including at least two execution modules including the steps of:
sending a start operation to an execution module to start the execution module as an active execution module;
sending an operation to a second execution module to cause it to act as a backup execution module to the active execution module;
creating transactional state items in the active execution module by retrieving information corresponding to the transactional state items from a database module;
sending at least one checkpoint message from the active execution module to the second execution module to replicate the created transactional state items.

27. The method for initializing a transaction processing system of claim 26, wherein at least one transactional state item includes the value of a container-managed persistence field of an Enterprise JavaBean entity object.

28. The method for initializing a transaction processing system of claim 26, wherein at least one transactional state item is an object of an object-oriented programming language.

29. The method for initializing a transaction processing system of claim 26, wherein the start operation includes information indicating to create at least one transactional state item.

30. A method for initializing a transaction processing system including a plurality of execution modules including the steps of:
sending a start operation to at least one execution module to start the execution module as an active execution module;
sending an operation to at least one other execution module to cause the creation of at least one backup execution module corresponding to the active execution module;
creating transactional state items in the active execution module by retrieving information corresponding to the transactional state items from a database module; and
sending at least one checkpoint message from the active execution module to the at least one other execution module to replicate the created transactional state items.

31. A method for failure recovery in a transaction processing system including a plurality of execution modules including the steps of:
creating an active execution module capable of storing transactional state items accessible from multiple clients;
creating at least one backup execution module corresponding to the active execution module;
storing copies of the transactional state items located on the active execution module on the at least one backup execution modules;
detecting a failure in an active execution module; and
promoting one of the at least one backup execution modules corresponding to the failed active execution module to an active execution module.

32. The method for failure recovery of claim 31, wherein at least one transactional state item includes the value of a container-managed persistence field of an Enterprise JavaBean entity object.

33. The method for failure of claim 31, wherein at least one transactional state item is an object of an object-oriented programming language.

34. A method for upgrading an execution module in a transaction processing system including a plurality of execution modules including the steps of:
starting a new execution module as a replacement execution module with a new version of transaction programs;
sending a stop message to a second execution module with an old version of transactional programs to stop the second execution module from processing transactions;
causing a communication module to block requests to the second execution module;
sending a start message to the new execution module indicating that it is a replacement execution module for the second execution module;
enabling the replacement execution module to access the transactional state items located in the second execution module;
retrieving at least one of the transactional state items located in the second execution module and creating at least one transactional state item in the new execution module;
causing the communication module to replaces routes to the second execution module with routes to the new execution module.

35. The method of upgrading of claim 34, wherein the enabling step includes reformatting the transactional state items of the second execution module to the format according to the new execution module.

36. The method for upgrading of claim 35, wherein at least one transactional state item includes the value of a container-managed persistence field of an Enterprise JavaBean entity object.

37. The method for upgrading of claim 34, wherein at least one transactional state item is an object of an object-oriented programming language.

38. The method of upgrading of claim 34, wherein the causing of a communication module to block requests occurs before the sending of a stop message.

39. A method for processing transaction requests in a transaction processing system including at least one active execution module, at least one backup execution module and a communication module, the method includes the steps of:
submitting at least a first and second transaction request from at least one client to the communication module;
modifying the value of a transactional state item with the first transaction, and
specifying a read of a value of a transactional state item modified by the first transaction and beginning processing after the first transaction with the second transaction;
processing the first transaction and sending a checkpoint message;
processing the second transaction without sending a response message;
sending the acknowledgement message for the first transaction from the backup execution module to the active execution module; and
sending the response for at least the second transaction from the active the active execution module to the communication module.

40. The method for processing transaction requests of claim 39, wherein at least one transactional state item includes the value of a container-managed persistence field of an Enterprise JavaBean entity object.

41. The method for processing transaction requests of claim 39, wherein at least one transactional state item is an object of an object-oriented programming language.

42. A method for processing transaction requests in a transaction processing system including at least one active execution module, at least one backup execution module and a communication module, the method including the steps of:
submitting at least two transaction requests from at least one client to the communication module;
processing at least two transactions and sending separate checkpoint messages for each of the at least two transactions, the checkpoint messages including a sequence number indicating the order of the transactions; and
processing the checkpoint messages in a backup execution module in an order based on sequence numbers of the checkpoint message.

43. The method for processing transaction requests of claim 42, further including the steps of:
sending an acknowledgement message from the backup execution module to the active execution module upon completion of the processing of the checkpoint message; and
sending a response message from the active execution module to the client.

44. A transaction processing system including:
logic configured to allow multiple clients to share access to the same transactional state item;
a communication module, the communication module including routing logic configured to receive transaction requests and forward the transaction requests to an active execution module;
a plurality of execution modules, each execution module including:
at least one transaction program and at least one persistent transactional state item, each transaction program including logic configured to process transaction requests; and
access logic configured to access a transactional state item;
and wherein at least one first execution module is configured in an active mode and at least one second execution module is configured in a backup mode, the second execution module containing a copy of at least one transactional state item that is held in the first execution module.

45. The transaction processing system of claim 44, wherein the at least one transactional state item includes trigger logic configured to execute a second transaction program at a specified time.

46. The transaction processing system of claim 44, further including transaction management logic configured to restore at least one transactional state item to a pre-transaction value.

47. The transaction processing system of claim 46, wherein the logic configured to restore transactional state items upon a failure of the transaction program is separate from the transaction program.

48. The transaction processing system of claim 44, further including transaction management logic configured to restore at least one transactional state item to a pre-transaction value upon a failure of the transaction program.

49. The transaction processing system of claim 44, in which the execution module includes a plurality of transaction programs.

50. The transaction processing system of claim 44, in which the execution module includes a plurality of transactional state items.

51. The transaction processing system of claim 44, wherein at least one first execution module includes logic, separate from any transaction program, configured to send a checkpoint message to at least one second execution module.

52. The transaction processing system of claim 44, wherein at least one first execution module includes logic configured to send a checkpoint message to at least one second execution module.

53. The transaction processing system of claim 52, wherein at least one second execution module includes acknowledgement logic configured to receive a checkpoint message and thereupon send an acknowledgement message to at least one first execution module.

54. The transaction processing system of claim 53, wherein at least one second execution module is configured to update a transactional state item after receiving the checkpoint message and the acknowledgement logic is configured to send the acknowledgement message after the second execution module updates the transactional state item.

55. The transaction processing system of claim 44, wherein the routing logic is configured to route a plurality of transactions requests to a plurality of execution modules.

56. The transaction processing system of claim 55, wherein distribution logic is configured to configure the routing logic to route transaction requests based on a partition criteria.

57. The transaction processing system of claim 56, wherein the partition criteria partitions transactional state items to a plurality of execution modules.

58. The transaction processing system of claim 55, wherein distribution logic is configured to ensure that an active copy and a backup copy of each transactional state item are stored in separate execution modules.

59. The transaction processing system of claim 58, wherein the distribution logic is configured to store a transactional state item in one active execution module.

60. The transaction processing system of claim 59, wherein the distribution logic is configured to store a transactional state item in at least one backup execution module.

61. The transaction processing system of claim 57, wherein the partition is performed by partition logic, the partition logic including logic configured to identify and partition transactional state items though primary keys.

62. The transaction processing system of claim 55, wherein a received transaction request is directed to a selected transactional state item; and the routing logic is configured to send a transaction request to the execution module that includes an active copy of the transactional state item.

63. The transaction processing system of claim 55, wherein the distribution logic is configured to create sets of transactional states that are nearly uniform in size.

64. The transaction processing system of claim 55, wherein the distribution logic is configured to perform load balancing of the transactional state items among the execution modules.

65. The transaction processing system of claim 44, further including status change logic configured to change a status of an execution module from a backup mode to an active mode.

66. The transaction processing system of claim 65, wherein the status change logic is configured to execute the status change based upon unavailability of an active execution module.

67. The transaction processing system of claim 44, further including at least one client module including logic configured to send transaction requests to the communication module.

68. The transaction processing system of claim 67, further including an intermediate server;
wherein the client module includes logic configured to send a client request to the intermediate server; and
wherein the intermediate server includes logic configured to send at least one transaction request to the communication module based on at least one of the client requests.

69. The transaction processing system of claim 44, further including a plurality of hardware modules each of which includes:
at least one of the execution modules, wherein the distribution logic is configured to prevent an active copy and a backup copy of a single transactional state item from being stored in the same hardware module.

70. The transaction processing system of claim 69, wherein:
each hardware module includes at least one CPU and a memory module; and
the memory module includes at least one execution module.

71. The transaction processing system of claim 44, wherein at least one execution module includes lock logic configured to associate a lock with at least one transactional state item.

72. The transaction processing system of claim 71, wherein the lock logic is configured to acquire the lock before access logic accesses an associated transactional state item.

73. The transaction processing system of claim 71, wherein the lock is exclusive.

74. The transaction processing system of claim 71, wherein the lock is shared.

75. The transaction processing system of claim 44, wherein the execution module includes execution logic configured to execute at least a first transaction program, which is configured to maintain at least one item of the transactional state items in a programming-language variable of the transaction program.

76. The transaction processing system of claim 48, wherein at least one first execution module includes logic configured to send a checkpoint message to at least one second execution module and logic configured to execute at least a first transaction program, which is configured to maintain at least one item of the transactional state items in a programming-language variable of the transaction program.

77. The transaction processing system of claim 44, wherein at least one transaction program includes a method of a class of an object-oriented programming language.

78. The transaction processing system of claim 44, wherein:
the at least one transactional state item includes the value of a container-managed persistence field of Enterprise JavaBeans entity object; and
the at least one transaction program includes methods of Enterprise JavaBeans.

79. The transaction processing of claim 78, wherein the at one transactional state item includes trigger logic including an Enterprise JavaBeans timer configured to trigger the execution of a second transaction program at a specified time.

80. The transaction processing system of claim 44, wherein:
the at least one transactional state item includes Java Data Objects and the at least one transactional state items including the values of at least one field of the Java Data Objects; and
the at least one transaction program includes Java Data Object methods.

81. The transaction processing system of claim 44, wherein:
the at least one transactional state item includes objects of an object-oriented language and the at least one transactional state items including the values of fields of the objects of an object-oriented language; and
the at least one transaction program includes methods of an object-oriented language.

82. The transaction processing system of claim 48 wherein at least one first execution module includes logic configured to send a checkpoint message to at least one second execution module and
the at least one transactional state item includes Java Data Objects and the at least one transactional state items includes the values of at least one field of the Java Data Objects; and
the at least one transaction program includes Java Data Object methods.

83. The transaction processing system of claim 44, wherein:
the at least one transactional state item includes values of C# fields; and
the at least one transaction program includes C# methods.

84. The transaction processing system of claim 48 wherein at least one first execution module includes logic configured to send a checkpoint message to at least one second execution module and
the at least one transactional state item includes values of C# fields; and
the at least one transaction program includes C# methods.

85. The transaction processing system of claim 44, wherein the at least one transactional state item include instances of XML types and the at least one transactional state item includes values of XML elements.

86. The transaction processing system of claim 48 wherein at least one first execution module includes logic configured to send a checkpoint message to at least one second execution module and at least one transactional state items include instances of XML types and the at least one transactional state item includes values of XML elements.

87. The transaction processing system of claim 48 wherein at least one first execution module includes logic configured to send a checkpoint message to at least one second execution module and further including:
transaction management logic configured to restore at least one transactional state item to a pre-transaction value upon a failure of the transaction program; and
the at least one transactional state item include Service Data Objects.

88. The transaction processing system of claim 44, further including:
a database management module configured to receive messages from at least one execution module, and to communicate with at least one database module; and
at least one database module configured to store at least one record.

89. The transaction processing system of claim 88, wherein at least one execution module includes trigger logic configured to cause the database management module to perform a database update operation after the completion of a transaction program by the execution module.

90. The transaction processing system of claim 89, wherein the trigger logic modifies at least one transactional state item to indicate the need to update or modify the database module and to indicate the updates needed in the database module.

91. The transaction processing system of claim 89, wherein
the trigger logic creates at least one transactional state item to indicate the need to update or modify the database module and to indicate the updates needed in the database module.

92. The transaction processing system of claim 89, wherein at least one transactional state item refers to a second transactional state item which is to be updated in the database module.

93. The transaction processing system of claim 89, wherein at least one transactional state item refers to a plurality of transactional state items which are to be updated in the database module.

94. The transaction processing system of claim 89, wherein update logic is configured to process one or more transactional state items associated with multiple database update indications into a single database update operation.

95. The transaction processing system of claim 89, wherein the trigger logic modifies at least one transactional state item to indicate the need to update or modify the database module and to indicate the updates needed in the database module and update logic is configured to process one or more transactional state items associated with multiple database update indications into a single database update operation.

96. The transaction processing system of claim 44, further including:
an information processing system.

97. The transaction processing system of claim 96, wherein
the execution module includes trigger logic to create an update indication to perform an information processing system operation after the completion of the transaction program.

98. The transaction processing system of claim 97, wherein
the trigger logic creates or modifies at least one transactional state item to indicate the need to perform an information processing system operation.

99. The transaction processing system of claim 88, further including:
test logic to indicate if a transactional state item corresponding to a transaction request is located in an execution module;
logic responsive to the test logic indicating the transactional state item is not in an execution module and causing:
roll back of the transaction request;
retrieval of the transactional state item from the database module; and
restart of the transaction request.

100. The transaction processing system of claim 44, further including:
a database program module including logic which provides a database transaction which modifies the database module;
upon receipt of the database transaction database logic sends a transaction request to the communication module to update the transactional state item corresponding to the database transaction.

101. The transaction processing system of claim 44, further including:
poll logic in the active execution modules configured to poll the database module to determine if the database module changed a transactional state item corresponding to a transactional state item stored on the execution module;
if the logic finds such a transactional state item, the logic causes the execution module to create a local transaction program to update the active execution module and at least one backup execution modules which store the transactional state item.

102. The transaction processing system of claim 44, wherein:
the active execution module and at least one backup execution modules include logic to store records of the transaction requests they process;
upon the at least one backup execution modules receiving a transaction request logic is configured to determine if a record exists corresponding to the transaction request;
the logic is configured to respond with the record if the record exists on the backup execution module.

103. The transaction processing system of claim 102, where records include the reply information.

104. The transaction processing system of claim 44, in which at least one transactional state item represents an auction and at least one transactional state item represents a bid.

105. The transaction processing system of claim 44, wherein at least one of the transactional state items represents an auction.

106. The transaction processing system of claim 105, wherein at least one of the transactional state items represents a bid.

107. The transaction processing system of claim 105, wherein at least one first execution module includes logic configured to send a checkpoint message to at least one second execution module further including:
transaction management logic configured to restore at least one transactional state item to a pre-transaction value upon a failure of the transaction program;
a database management module configured to receive messages from at least one execution module, and to communicate with at least one database module; and
at least one database module configured to store at least one record.

108. The transaction processing system of claim 44, wherein at least one transactional state item represents a telephone call.

109. The transaction processing system of claim 108, wherein at least one first execution module includes logic configured to send a checkpoint message to at least one second execution module further including:
transaction management logic configured to restore at least one transactional state item to a pre-transaction value upon a failure of the transaction program.

110. The transaction processing system of claim 44, wherein at least one transactional state item represents the state of a running application.

111. The transaction processing system of claim 44, wherein at least one transactional state item represents the state of an execution module of a first application, the first application being different from a second application that includes said at least one transactional state item.

112. The transaction processing system of claim 44, wherein at least one transactional state item represents at least one radio frequency identification tag.

113. The transaction processing system of claim 110, wherein the running application includes a transaction program.

114. The transaction processing system of claim 110, wherein at least one first execution module includes logic configured to send a checkpoint message to at least one second execution module further including:
transaction management logic configured to restore at least one transactional state item to a pre-transaction value upon a failure of the transaction program.

115. The transaction processing system of claim 44, in which at least one transactional state item represents the state of a hardware module.

116. The transaction processing system of claim 115, wherein at least one first execution module includes logic configured to send a checkpoint message to at least one second execution module further including:
transaction management logic configured to restore at least one transactional state item to a pre-transaction value upon a failure of the transaction program.

117. A transaction processing system including:
logic configured to allow multiple clients to share access to the same transactional state item;
a communication module, the communication module including routing logic configured to receive transaction requests and forward the transaction request to an active execution module;
a plurality of execution modules, each execution module including:
at least one transaction program and at least one persistent transactional state item, each transaction program including logic configured to process transaction requests; and
access logic configured to access a transactional state item;
and wherein at least one first execution module is configured in an active mode and includes logic configured to send a checkpoint message to at least one second execution module and at least one second execution module is configured in a backup mode, the second execution module containing a copy of at least one transactional state item that is held in the first execution module;
transaction management logic configured to restore at least one transactional state item to a pre-transaction value upon a failure of the transaction program;
the at least one transactional state item includes the value of a container-managed persistence field of Enterprise JavaBeans entity object; and
the at least one transaction program includes methods of Enterprise JavaBeans.

118. A transaction processing system including:
logic configured to allow multiple clients to share access to the same transactional state item;
a communication module, the communication module including routing logic configured to receive transaction requests and forward the transaction request to an active execution module;
a plurality of execution modules, each execution module including:
at least one transaction program and at least one persistent transactional state item, each transaction program including logic configured to process transaction requests; and
access logic configured to access a transactional state item;
and wherein at least one first execution module is configured in an active mode and includes logic configured to send a checkpoint message to at least one second execution module and at least one second execution module is configured in a backup mode;
the second execution module containing a copy of at least one transactional state item that is held in the first execution module;
transaction management logic configured to restore at least one transactional state item to a pre-transaction value upon a failure of the transaction program;
the at least one transactional state item includes the values of fields of the objects of an object-oriented language; and
the at least one transaction program includes methods of an object-oriented language.
